(19) United States
(12) Patent Application Publication
(10) Pub. No.: US 2015/0061398 A1
(43) Pub. Date: Mar. 5, 2015

(54) Power Transmitting Apparatus, Power Receiving Apparatus, and Wireless Power Transmission System

(71) Applicant: Kabushiki Kaisha Toshiba, Tokyo (JP)

(72) Inventors: Hiroki KUDO, Kawasaki-Shi (JP); Hiroyuki Kitagawa, Yokohama-Shi (JP); Yuji Tohzaka, Kawasaki-Shi (JP); Takafumi Sakamoto, Tokyo (JP)

(73) Assignee: Kabushiki Kaisha Toshiba, Tokyo (JP)

(21) Appl. No.: 14/175,464

(22) Filed: Feb. 7, 2014

Related U.S. Application Data
(63) Continuation of application No. PCT/JP2013/074171, filed on Sep. 3, 2013.

(51) Int. Cl. H04B 5/00

(52) U.S. Cl. CPC H04B 5/0037
USPC 307/104

(57) ABSTRACT

There is provided a power transmitting apparatus in which the first communicating unit performs communication with a power receiving apparatus using the first antenna, the second antenna transmits the electric power generated by the power supply unit to the power receiving apparatus, the second communicating unit performs communication with the power receiving apparatus using the second antenna, the measuring unit measures first and second communication quality of the first and second communicating units, respectively, the control unit communicates, while power transmission to the power receiving apparatus is performed, transmission control information with the power receiving apparatus using the first or second communicating unit and controls the power transmission based on the transmission control information, and the control unit selects any one of the first communicating unit and the second communicating unit according to the first communication quality and the second communication quality to communicate the transmission control information.

### CROSS REFERENCE TO RELATED APPLICATIONS

This application is a Continuation of International Application No. PCT/JP2013/074171, filed on Sep. 3, 2013, the entire contents of which is hereby incorporated by reference.

### FIELD

An embodiment described herein relates to a power transmitting apparatus, a power receiving apparatus, and a wireless power transmission system.

### BACKGROUND

In a communication apparatus, a long-term communication interruption due to a fault or the like and a temporary communication interruption due to interference, noise, or the like occur. A wireless power transmission apparatus includes a radio communication device for wireless power transmission control. However, when the radio communication device is interrupted, it is necessary to stop power transmission in order to secure safety. On the other hand, a method of duplicating communicating means as a technique for improving the reliability of communication is widely known. Further, in the wireless power transmission apparatus, there is known a method of providing two communicating means in which one of the communicating means performs communication between coils for power transmission, although the method is not a technology for improving reliability. In the wireless power transmission apparatus, by using the inter-coil communication, it is possible to save a space when the wireless power transmission apparatus includes a plurality of communicating means.

However, in the latter method, which is a related art, transmission and reception of initial setting for a radio communication device for contents (transmission and reception of an SSID or the like in a wireless LAN) is performed in the inter-coil communication. Communication of transmission control for wireless power transmission is performed by the inter-coil communication. In particular, when load modulation used in, for example, RFID is applied when the inter-coil communication is performed during the wireless power transmission, power transmission efficiency is deteriorated because load impedance on a power receiving side changes. When transmitting and receiving units for the inter-coil communication has broken down, power transmission is stopped.

In this way, in the wireless power transmission apparatus in the past, the wireless power transmission is stopped during a communication interruption and the power transmission efficiency is deteriorated during control of the wireless power transmission.

### BRIEF DESCRIPTION OF THE DRAWINGS

FIG. 1 is a diagram showing an example 1 of a wireless power transmission system according to an embodiment;

FIG. 2 is a diagram showing an example 2 of the wireless power transmission system according to the embodiment;

FIG. 3 is a diagram showing a first configuration example of a power transmitting apparatus for wireless power transmission according to the embodiment;

FIGS. 4A and 4B are diagrams each showing a list of control procedure in the power transmitting apparatus for wireless power transmission according to the embodiment;

FIG. 5 is a state transition chart in a first operation example of the power transmitting apparatus for wireless power transmission according to the embodiment;

FIG. 6 is a flowchart 1 at the time of startup of a normal mode in the power transmitting apparatus for wireless power transmission according to the embodiment;

FIG. 7 is a flowchart 2 at the time of startup of the normal mode in the power transmitting apparatus for wireless power transmission according to the embodiment;

FIG. 8 is a flowchart during power transmission in the normal mode in the power transmitting apparatus for wireless power transmission according to the embodiment;

FIG. 9 is a flowchart at the time of startup of an interruption 1 mode in the power transmitting apparatus for wireless power transmission according to the embodiment;

FIG. 10 is a diagram showing an example of communication timing, a data cycle, and a data type in the power transmitting apparatus for wireless power transmission according to the embodiment;

FIG. 11 is a diagram showing an example of a mixed method of wireless power transmission and radio communication at the time of transmission of a plurality of data types in the power transmitting apparatus for wireless power transmission according to the embodiment;

FIG. 12 is a flowchart during power transmission in the interruption 1 mode in the power transmitting apparatus for wireless power transmission according to the embodiment;

FIG. 13 is a diagram showing an example of a method of transition to the interruption 1 mode during power transmission in the power transmitting apparatus for wireless power transmission according to the embodiment;

FIG. 14 is a flowchart at the time of startup of an interruption 2 mode in the power transmitting apparatus for wireless power transmission according to the embodiment;

FIG. 15 is a flowchart during power transmission in the interruption 2 mode in the power transmitting apparatus for wireless power transmission according to the embodiment;

FIG. 16 is a flowchart at the time of startup of a full interruption mode and during power transmission in the power transmitting apparatus for wireless power transmission according to the embodiment;

FIG. 17 is a flowchart at the time of communication interruption in the power transmitting apparatus for wireless power transmission according to the embodiment;

FIG. 18 is a diagram showing an example of a receiving method for an emergency signal in the power transmitting apparatus for wireless power transmission according to the embodiment;

FIG. 19 is a diagram showing an example of a wireless power transmission system that can stop power transmission by a power receiving apparatus protection circuit operation in the power transmitting apparatus for wireless power transmission according to the embodiment;

FIG. 20 is a diagram showing a second configuration example 1 in the power transmitting apparatus for wireless power transmission according to the embodiment;

FIG. 21 is a diagram showing a second configuration example 2 in the power transmitting apparatus for wireless power transmission according to the embodiment;

FIG. 22 is a diagram showing a second configuration example 3 in the power transmitting apparatus for wireless power transmission according to the embodiment;

FIG. 23 is a diagram showing a second configuration example 4 in the power transmitting apparatus for wireless power transmission according to the embodiment;

FIG. 24 is a diagram showing a first configuration example of a power receiving apparatus for wireless power transmission according to the embodiment;

FIG. 25 is a diagram showing a first configuration example of a wireless power transmission system according to the embodiment;

FIG. 26 is a diagram showing a flowchart and a communication procedure at the time of startup of a normal mode in a first operation example of the wireless power transmission system according to the embodiment;

FIG. 27 is a diagram showing a flowchart and a communication procedure during power transmission in the normal mode in the first operation example of the wireless power transmission system according to the embodiment;

FIG. 28 is a diagram showing a flowchart and a communication procedure at the time of startup of an interruption 1 mode in the first operation example of the wireless power transmission system according to the embodiment;

FIG. 29 is a diagram showing a flowchart and a communication procedure during power transmission in the interruption 1 mode in the first operation example of the wireless power transmission system according to the embodiment;

FIG. 30 is a diagram showing a flowchart and a communication procedure at the time of startup of an interruption 2 mode in the first operation example of the wireless power transmission system according to the embodiment;

FIG. 31 is a diagram showing a flowchart and a communication procedure during power transmission in the interruption 2 mode in the first operation example of the wireless power transmission system according to the embodiment;

FIG. 32 is a diagram showing a flowchart and a communication procedure at the time of startup of a full interruption mode and during power transmission in the first operation example of the wireless power transmission system according to the embodiment; and

FIG. 33 is a diagram showing a second configuration example of the wireless power transmission system according to the embodiment.

### DETAILED DESCRIPTION

According to some embodiments, there is provided a power transmitting apparatus including: a first antenna, a first communicating unit, a power supply unit, a second antenna, a second communicating unit, a measuring unit and a control unit.

The first communicating unit performs communication with a power receiving apparatus using the first antenna.

The power supply unit generates electric power.

The second antenna transmits the electric power generated by the power supply unit to the power receiving apparatus.

The second communicating unit performs communication with the power receiving apparatus using the second antenna.

The measuring unit measures first communication quality of the first communicating unit and second communication quality of the second communicating unit.

The control unit communicates, while power transmission to the power receiving apparatus is performed, transmission control information with the power receiving apparatus using the first communicating unit or the second communicating unit and controls the power transmission to the power receiving apparatus on the basis of the transmission control information.

The control unit selects any one of the first communicating unit and the second communicating unit according to the first communication quality and the second communication quality to communicate the transmission control information.

An embodiment will be explained in detail below with reference to the accompanying drawings.

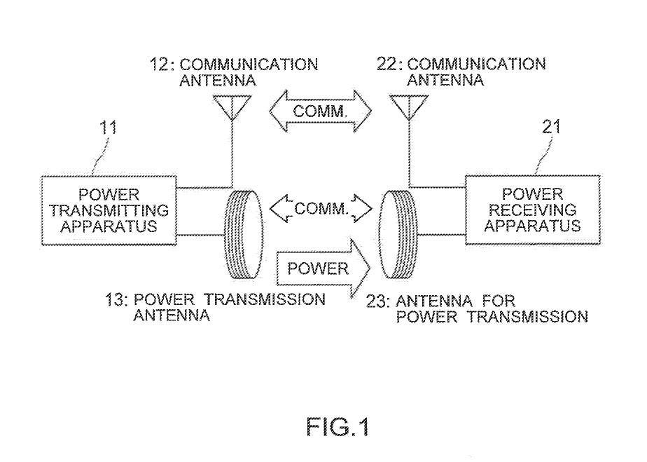

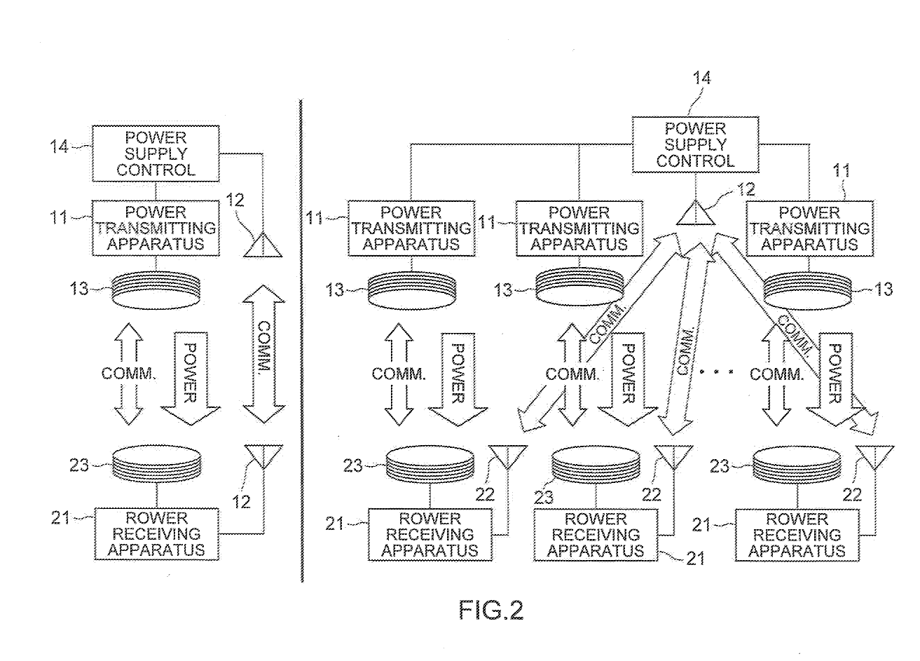

(FIGS. 1 and 2: An Example of a Wireless Power Transmission System to which the Embodiment is Applied)

FIG. 1 shows an example of a wireless power transmission system according to the embodiment. According to FIG. 1, the embodiment is applied to a system that supplies electric power from a power transmitting apparatus 11 to at least one power receiving apparatus 21 by radio in a non-contact manner. The power transmitting apparatus 11 includes a communication antenna 12 and a power transmission antenna 13 (coils in the figure, hereinafter referred to as power transmission coils). Similarly, the power receiving apparatus 21 includes a communication antenna 22 and an antenna for power transmission 23. Inter-coil communication is performed using the power transmission coils 13 and 23. Whereas power transmission is performed in one-way from the power transmitting apparatus 11 to the power receiving apparatus 21, communication is performed in two-way. Note that one power transmitting apparatus 11 and one power receiving apparatus 21 are provided. However, the embodiment can be applied in the same manner when a plurality of the power transmitting apparatuses are provided, when a plurality of the power receiving apparatuses are provided, and when a plurality of the power transmitting apparatuses and a plurality of the power receiving apparatuses are provided. Note that, in the figure, although the power transmission is performed in only one-way from the power transmitting apparatus 11 to the power receiving apparatus 21, the power transmission in two-way can be applied in the same manner. A direction of inter-coil communication performed using the power transmission coils is also two-way in the figure. However, the power transmission can also be sufficiently applied only to one-way from the power receiving apparatus to the power transmitting apparatus, for example.

FIG. 2 shows another example of the wireless power transmission system according to the embodiment. In the left diagram of FIG. 2, the power transmitting apparatus 11 is connected to a power-supply control apparatus 14. For example, at home, the power-supply control apparatus 14 indicates an entire control apparatus including a power supply such as a wiring interrupter. The power-supply control apparatus 14 includes the communication antenna 12. The right diagram of FIG. 2 shows a configuration in which a plurality of power transmitting apparatuses 11 are connected to one power-supply control apparatus 14 and supply electric power to the respective receiving apparatuses 21. The power-supply control apparatus 14 is connected to a plurality of power receiving apparatuses 21 by radio communication and configured to control electric power and the like output from the power transmitting apparatuses 11. As in the example shown in FIG. 1, exchange of electric power and radio communication are performed between the coils 13 and 23. The communication may be either two-way or one-way. The electric power can be applied in the same manner to one-way and two-way.

According to the embodiment, the wireless power transmission system performs power transmission control and safety maintenance control, when safety is spoiled, for example, in breakage of an apparatus, by using radio communication. The transmission control adjusts electric power, voltage and electric current to what a load of the power receiving apparatus requests. As transmission control information exchanged in the transmission control, information described below is conceivable.
Electric power, electric current and voltage information at respective measurement points
Frequency information at the respective measurement points
Switching speed of a rectifier or an inverter
Resistance value information of a load
Requested electric power, electric current, and voltage information of the load
Charging information when the load is a battery

A wireless power transmission apparatus (which represents a power transmitting apparatus, a power receiving apparatus or both of them) includes a plurality of blocks such as a power supply, an inverter, a coil, a rectifier, and a load. Electric power, electric current, and voltage information is monitored in necessary places of the respective blocks. The “respective measurement points” indicate places where electric power, electric currents and voltages are measured in the respective blocks or among the blocks. The transmission control information exchanged before power transmission is performed is called as pre-power transmission information and the transmission control information exchanged during which power transmission is performed is called as power transmission information.

Safety control information used in the safety maintenance control is listed below.
Temperature information at the respective measurement points
Electric power, electric current, and voltage information at the respective measurement points
Charging information used when the load is a battery
Authentication information

Note that the information used for the control is not limited to the above. Any information can be applied as long as the information is used for control for maintaining safety. The safety control information may be defined as being included in the transmission control information.

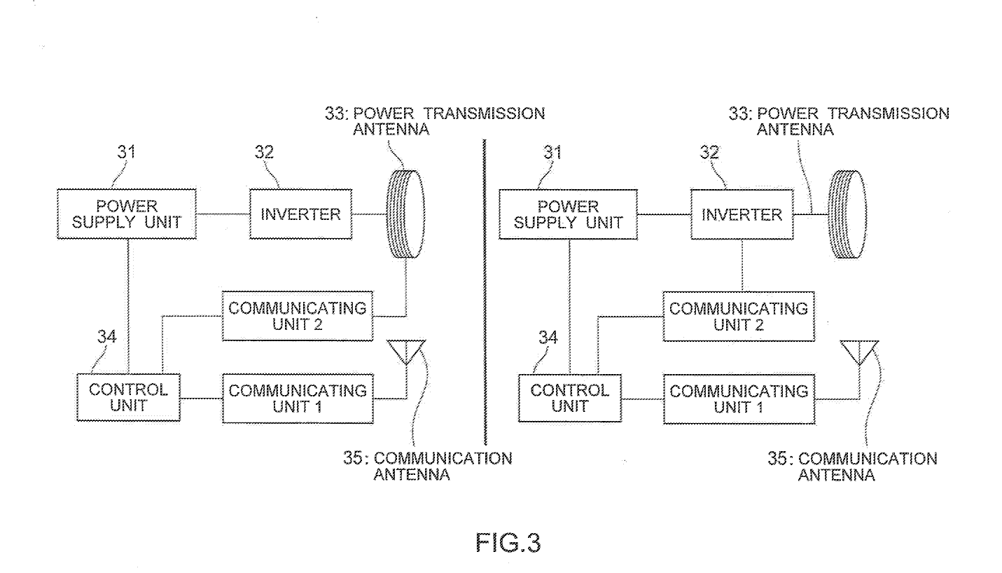

### (FIG. 3: A First Configuration Example of a Power Transmitting Apparatus for Wireless Power Transmission According to the Embodiment)

FIG. 3 shows a first configuration example of a power transmitting apparatus for wireless power transmission according to the embodiment. According to FIG. 3, the power transmitting apparatus includes a power supply unit 31 functioning as a power supply, an inverter 32 for conversion into predetermined electric power, electric current, voltage and frequency, a power transmission antenna 33, a control unit 34 configured to perform control of power transmission, a communication antenna 35 used for collecting parameters necessary for the control of the power transmission in the control unit 34, a communicating unit 1 connected to the communication antenna 35, and a communicating unit 2 connected to the power transmission antenna. The control unit 34 selects at least one of the communicating unit 1 and the communicating unit 2 and exchanges parameters necessary for the control of the power transmission with a power receiving apparatus. The control unit 34 includes a measuring unit configured to measure communication quality between the communicating unit 1 and the power receiving apparatus (first communication quality) and communication quality between the communicating unit 2 and the power receiving apparatus (second communication quality). When the first communication quality is lower than a first standard, the control unit 34 determines that communication between the communicating unit 1 and the power receiving apparatus is in an interrupted state. When the first communication quality is equal to or higher than the first standard, the control unit 34 determines that the communication between the communicating unit 1 and the power receiving apparatus is in a link stable state. When the second communication quality is lower than a second standard, the control unit 34 determines that communication between the communicating unit 2 and the power receiving apparatus is in an interrupted state. When the second communication quality is equal to or higher than the second standard, the control unit 34 determines that the communication between the communicating unit 2 and the power receiving apparatus is in a link stable state.

A difference between the left diagram and the right diagram of FIG. 3 is whether the communicating unit 2 is connected to the power transmission antenna 33 or connected to the inverter 32. Load modulation (backscatter modulation) that is used for RFID and the wireless power transmission system for small power devices, can be applied to the communicating unit 2. In this case, a load modulation circuit for performing the load modulation may be connected to either the front or the back of the inverter. Otherwise, it is also possible to directly connect between a switching control unit of the inverter 32 and a load modulation circuit in order to generate a signal using a switch of the inverter.

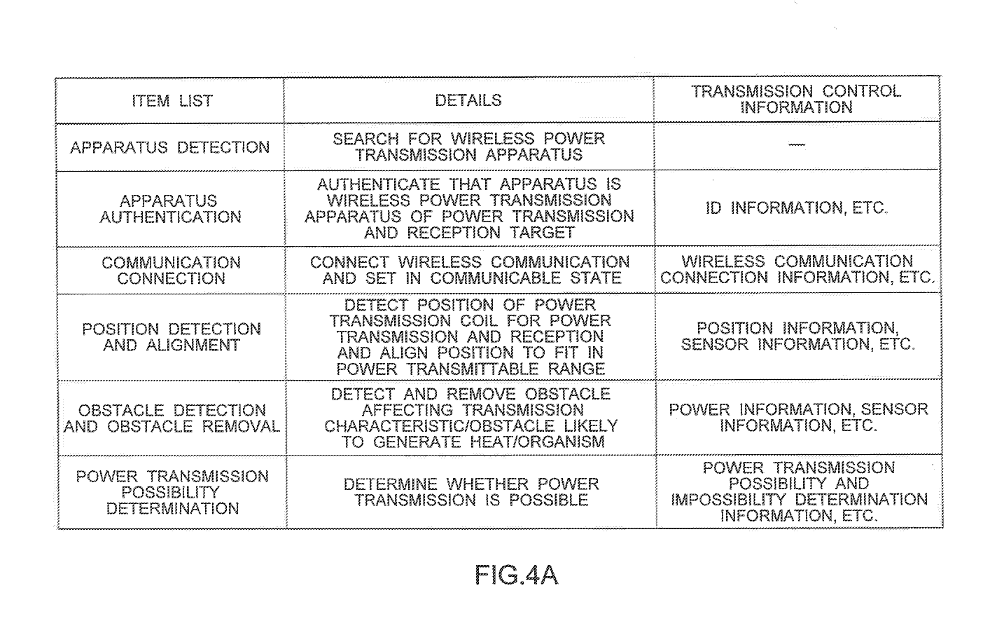

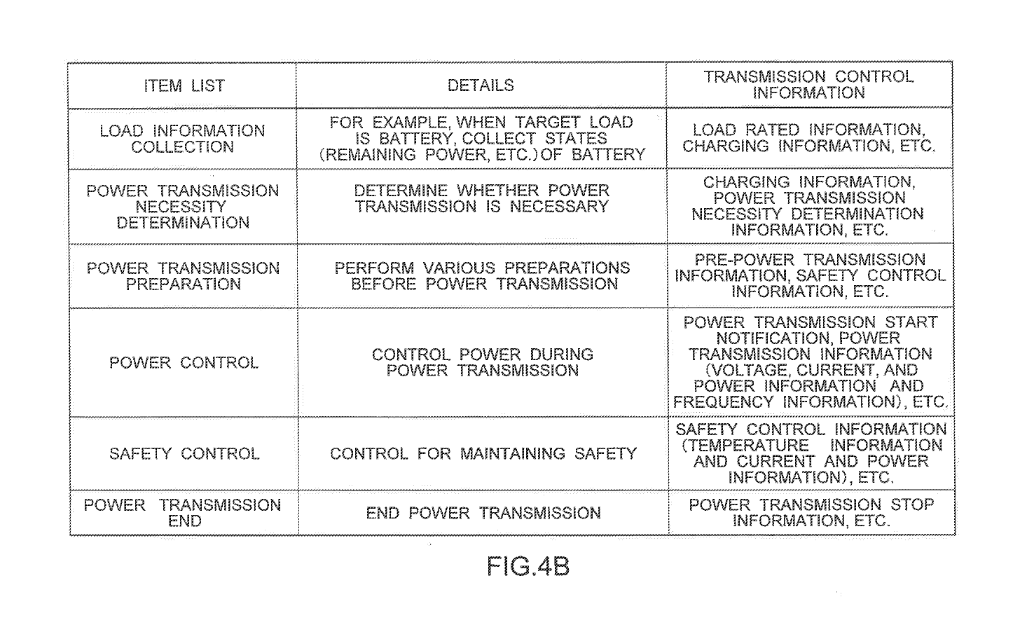

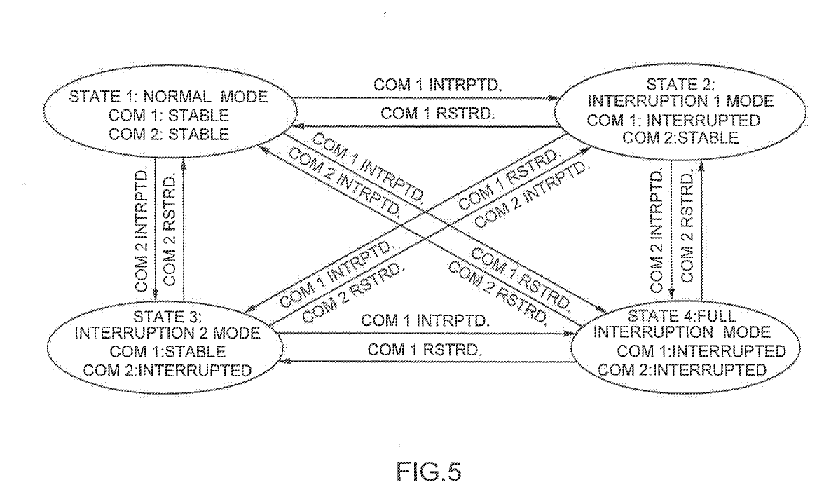

### (FIGS. 4A, 4B and 5: A First Operation Example of the Power Transmitting Apparatus for Wireless Power Transmission According to the Embodiment)

First, a list of control items in the power transmitting apparatus for wireless power transmission according to the embodiment is shown in FIGS. 4A and 4B. The power transmitting apparatus for wireless power transmission according to the embodiment needs to carry out several control items among the items shown in FIGS. 4A and 4B. For example, in the case of a system that starts power transmission when a user sets a power receiving apparatus in a power transmittable range, position detection and alignment are unnecessary because the user performs the position detection and the alignment. Note that the order for carrying out the control items can be flexibly changed according to an application and a system to which the control items are applied.

The first operation example of the embodiment in the first configuration example is explained. In the first operation example, the power transmitting apparatus for wireless power transmission transitions to any one of the states shown in FIG. 5. Operation procedures are different in the respective states. Excerpts from FIG. 5 are as described below,

State 1 (normal mode): communicating unit 1=link stable communicating unit 2=link stable

State 2 (interruption 1 mode): communicating unit 1 interrupted communicating unit 2=link stable

State 3 (interruption 2 mode): communicating unit 1=link stable communicating unit 2=interrupted

State 4 (full interruption mode): communicating unit 1=interrupted communicating unit 2=interrupted

Operation procedures in the respective states are shown in the figures.

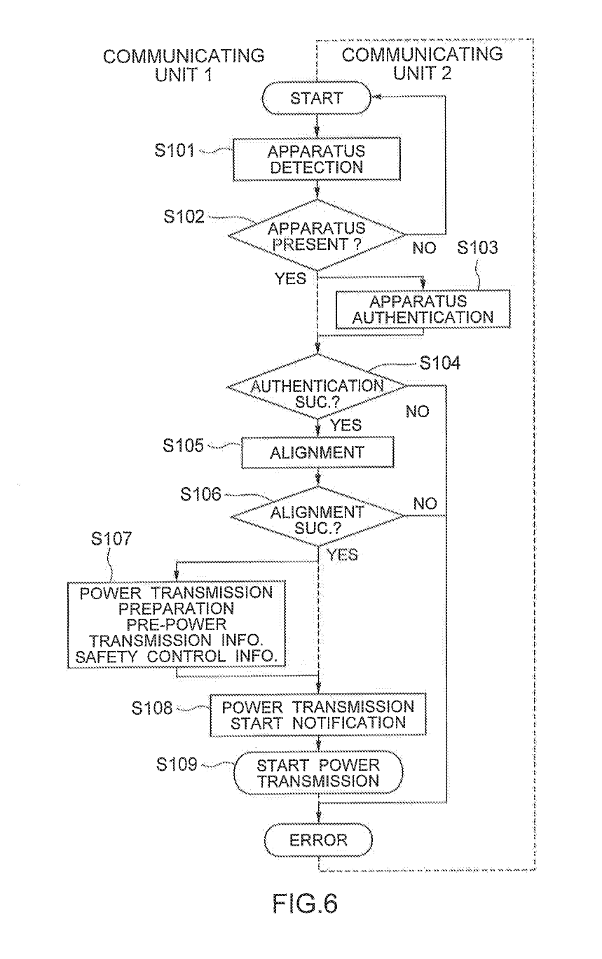

### (FIG. 6: A Flowchart at the Time of Startup in the Normal Mode (the State 1))

An example of a flowchart at the time of startup of wireless power transmission in the normal mode is shown in FIG. 6. A flow shown in FIG. 6 is explained in order. In FIG. 6, apparatus detection, apparatus authentication, alignment, and power transmission preparation are carried out in this order. Besides, power transmission necessity determination, obstacle detection/obstacle removal, load information collection, and the like may be carried out additionally. The procedures shown in FIG. 6 may be interchanged. For example, the alignment and the apparatus authentication may be interchanged.

As a first procedure, the power transmitting apparatus performs apparatus detection for searching for a power receiving apparatus (S101). For the apparatus detection, the communicating unit 1 may be used or the communicating unit 2 may be used. An advantage of performing the apparatus detection using the communicating unit 1 is that, for example, it is possible to detect a target power receiving apparatus from a relatively wide range compared with the apparatus detection using the communicating unit 2. However, for the detection of a power receiving apparatus, it is necessary to always supply electric power to the communicating unit 1. Therefore, there is a disadvantage that consumed power increases. An advantage of performing the apparatus detection using the communicating unit 2 is that, for example, in particular, it is possible to reduce consumed power on a power receiving apparatus side. However, as explained above, the communicating unit 2 has an extremely narrow communicable range, there is a disadvantage that an apparatus detectable range is narrow. If a power receiving apparatus is found (Yes in S102), the power transmitting apparatus shifts to the next procedure. If a power receiving apparatus is not found (No in S102), the power transmitting apparatus repeats the apparatus detection. The apparatus detection may be always performed or may be cyclically performed. When the apparatus detection is cyclically performed, consumed power can be reduced compared with power consumed when the apparatus detection is always performed. Note that the apparatus detection may be performed by means other than the communicating unit 1 and the communicating unit 2. For example, a sensor, a camera, or a separate communication apparatus may be used.

When a power receiving apparatus is detected by the apparatus detection, the power transmitting apparatus performs authentication of the power receiving apparatus in order to determine whether the power receiving apparatus is a malicious apparatus having a purpose of a power theft or an obstacle (S103). As the apparatus authentication, because of an advantage that a communicable range is limited when the communicating unit 2 is used, it is possible to perform authentication with high confidentiality. When the apparatus authentication is successful (Yes in S104), the power transmitting apparatus shifts to the next procedure. When the apparatus authentication is unsuccessful (No in S104), the power transmitting apparatus transitions to an error state. Rather than transitioning to the error state when the apparatus authentication is unsuccessful once, the power transmitting apparatus may transition to the error state when the apparatus authentication is continuously unsuccessful a plurality of times. Not that the power transmitting apparatus may perform the apparatus authentication simultaneously with the apparatus detection or before the apparatus detection.

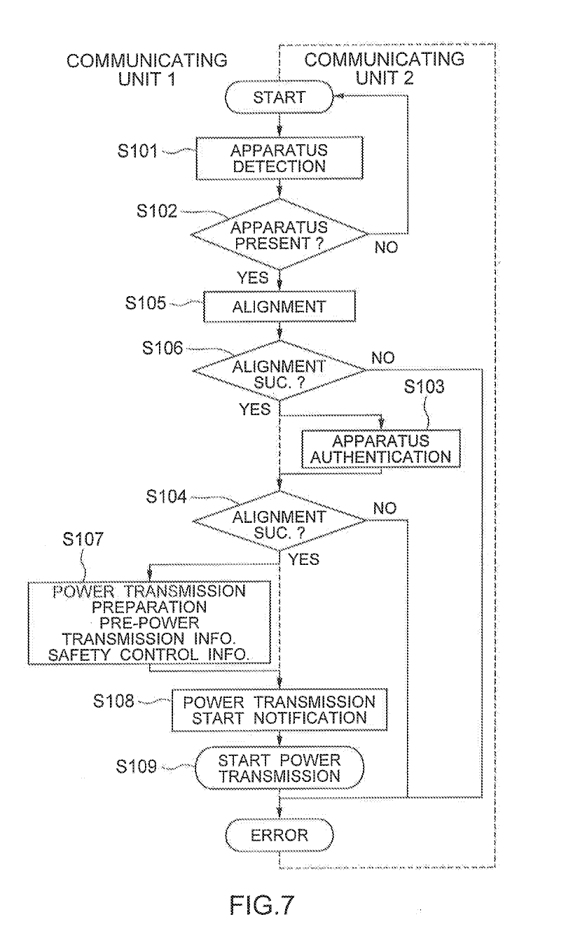

When the apparatus authentication ends, the power transmitting apparatus performs alignment (S105). The alignment is a procedure for correcting a positional relation between the power transmitting apparatus and the power receiving apparatus for improving power transmission efficiency. When a power transmission characteristic acquired in the communicating unit 2 is used for the alignment, it is desirable to use the communicating unit 2. However, the alignment can be realized by the communicating unit 1 as well. Note that the alignment performed using the communicating unit 1 or 2 could be sometimes unnecessary. For example, when a setting position of the power receiving apparatus is explicitly marked in a power transmitting apparatus main body and a user arranges the power receiving apparatus in the setting position, communication is unnecessary and the user performs the alignment. As shown in FIG. 7, the order of the alignment may be interchanged with the order of the apparatus detection and the apparatus authentication performed at the pre-stage of the alignment. When the alignment is successful (Yes in S106), the power transmitting apparatus shifts to the next procedure. When the alignment is unsuccessful (No in S106), the power transmitting apparatus transitions to the error state. Note that, as a method of determining that the alignment is unsuccessful, it is possible to apply a method of setting time length from the start of the alignment as a threshold and determining that the alignment is unsuccessful if the alignment cannot be successfully performed for a fixed time or longer. Other determining methods may be used. There is also a method of performing the alignment using the communicating unit 1 or 2. A sensor, a camera, a separate communication apparatus, or the like may be used. Any method can be applied. When the alignment is performed, it is also possible to perform calibration necessary at the time of start of power transmission.

When the alignment ends, the power transmitting apparatus performs to exchange pre-power transmission information and safety control information necessary at the start of power transmission (S107). The information is transmitted using the communicating unit 1. In general, the communicating unit 1 has a high transmission rate compared with the communicating unit 2. Therefore, when the communicating unit 1 is used, the power transmitting apparatus can shift to the start of power transmission more quickly than when the communicating unit 2 is used.

When the exchange of the pre-power transmission information and the safety control information ends, the power transmitting apparatus transmits a power transmission start notification (S108) and starts power transmission (S109). The power transmitting apparatus may transmit the power transmission start notification using either the communicating unit 1 or the communicating unit 2. The power transmitting apparatus may start the power transmission without transmitting the power transmission start notification.

Note that, for the position detection, the alignment, and the obstacle detection shown in FIGS. 4A and 4B, a method of using a characteristic of inter-coil communication performed as the communicating unit 2 or a transmission characteristic at the time of power transmission may be used. For example, when these characteristics are used for the alignment, a coupling strength of a power transmission coil between power transmission and reception is can be estimated by using any one of the electric power, a voltage, an electric current, and a frequency characteristic. Besides, it is possible to judge that the alignment has completed by using the maximum/optimum value of coupling strength. When coupling strength that enables power transmission is obvious, it is also possible to apply a method of setting the coupling strength capable of power transmission as a threshold and aligning the position to set the coupling strength to be equal to or higher than the threshold.

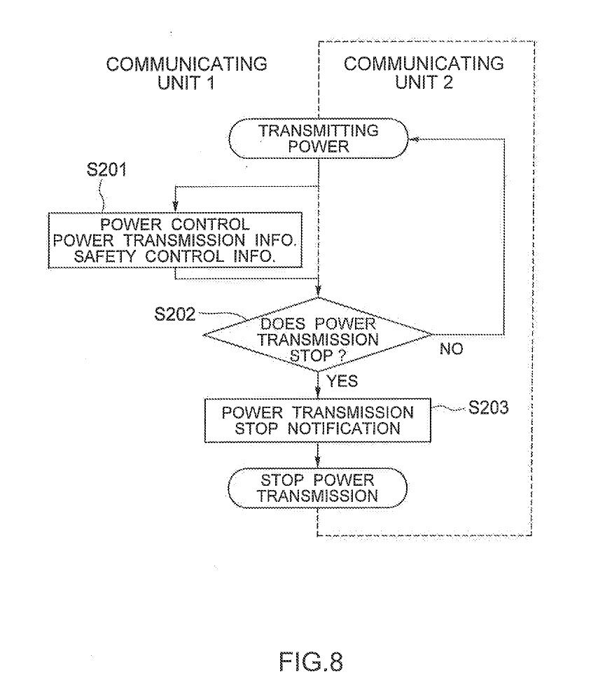

### (FIG. 8: A Flowchart During Power Transmission in the Normal Mode (the State 1))

A flowchart during power transmission of wireless power transmission in the normal mode is shown in FIG. 8. A flow shown in FIG. 8 is explained in order.

During the wireless power transmission, the power transmitting apparatus cyclically or suddenly performs a check of a transmission state, safety control, and radio communication of power transmission information and safety control information for charging control to a battery (S201). This is performed using the communicating unit 1. During power transmission, when communication is performed in the communicating unit 2 using, in particular, load modulation, deterioration in power transmission efficiency is caused. Therefore, it is desirable to use the communicating unit 1. When it is necessary to stop the power transmission (Yes in S202) or some error occurs, the power transmitting apparatus sends a power transmission stop notification and stops the power transmission (S203).

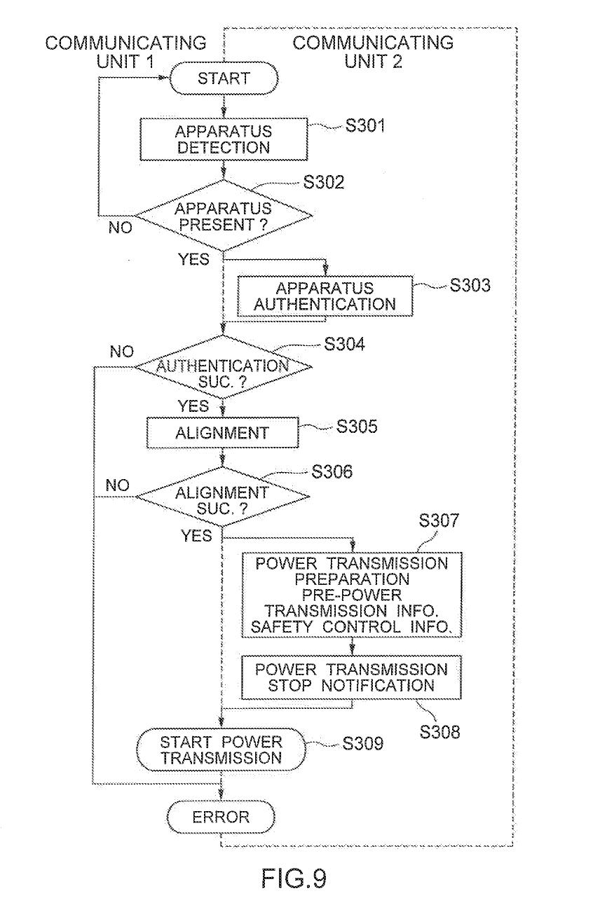

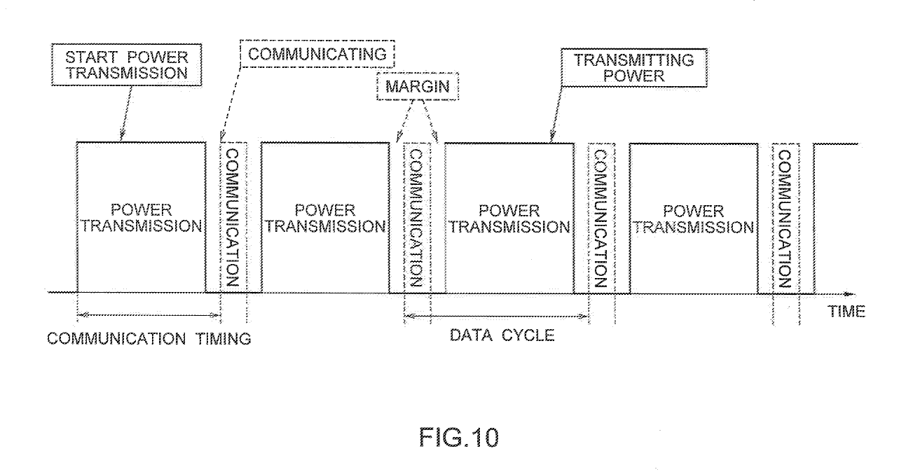

### (FIGS. 9 and 10: A Flowchart at the Time of Startup in the Interruption 1 Mode (the State 2))

A flowchart at the time of startup of wireless power transmission in the interruption 1 mode is shown in FIG. 9. The interruption 1 mode refers to a state in which communication by the communicating unit 1 is interrupted in a short term or a long term. Examples of a method of determining that communication is interrupted include a method of counting the number of times timeout of communication and a data loss occur and judging the counted number of times with a threshold. More specifically, it is possible to employ a method of determining that communication is interrupted if the timeout and the data loss continuously occur several times. Alternatively, it is possible to employ a method of setting upper limits of the timeout and the data loss and determining that communication is interrupted if the timeout and the data loss exceed the upper limits in a fixed time. Note that, as the method of determining interruption, besides the methods explained above, various methods can be applied without departing from the above. Note that it can be determined whether the communicating unit 1 is interrupted only when wireless connection and communication are performed by the communicating unit 1. Therefore, the power transmitting apparatus transitions to the interruption 1 mode at the first stage of the use of the communicating unit 1.

In the interruption 1 mode, the control is executed up to the power transmission start according to the same procedures as the procedures in the normal mode. However, the interruption 1 mode is different from the normal mode in that all the kinds of information exchanged by the communicating unit 1 in the normal mode are exchanged by the communicating unit 2.

First, in apparatus detection (S301), the method of detecting a power receiving apparatus using the communicating unit 2, a sensor, a camera, a separate communication apparatus, or the like may be used. Any method other than the detection by the communicating unit 1 can be applied. If a power receiving apparatus is found (Yes in S302), the power transmitting apparatus shifts to the next procedure. If a power receiving apparatus is not found (No in S302), the power transmitting apparatus repeats the apparatus detection.

Subsequently, the power transmitting apparatus performs apparatus authentication (S303) using the communicating unit 2 as in the normal mode. When the apparatus authentication is successful (Yes in S304), the power transmitting apparatus shifts to the next procedure. When the apparatus authentication is unsuccessful (No in S304), the power transmitting apparatus transitions to an error state. Note that, rather than transitioning to the error state when the apparatus authentication is unsuccessful once, the power transmitting apparatus may transition to the error state when the apparatus authentication is continuously unsuccessful a plurality of times. The power transmitting apparatus may perform the apparatus authentication simultaneously with the apparatus detection or before the apparatus detection.

When the apparatus authentication ends, the power transmitting apparatus performs alignment (S305). When a power transmission characteristic acquired by the communicating unit 2 is used for the alignment, it is desirable to use the communicating unit 2. However, any method of aligning a position using an apparatus other than the communicating unit 1 such as a sensor, a camera, or a communication apparatus can be applied. Note that the alignment performed using the communicating unit 2 or other apparatuses could be sometimes unnecessary. For example, when a setting position of the power receiving apparatus is explicitly marked in a power transmitting apparatus main body and a user arranges the power receiving apparatus in the setting position, communication is unnecessary and the user performs the alignment. The order of the alignment may be interchanged with the order of the apparatus detection and the apparatus authentication performed at the pre-stage of the alignment. It is also possible to perform, at the time of the alignment, calibration necessary at the time of power transmission start.

When the alignment ends (Yes in S306), subsequently, for power transmission preparation, the power transmitting apparatus exchanges pre-power transmission information and safety control information necessary at the start of power transmission (S307). The information is transmitted using the communicating unit 2. At this point, information for notifying that the communicating unit 1 is interrupted and basic information for using the wireless power transmission and the inter-coil communication in common are exchanged in advance. Examples of the basic information include several items described below.
Communication timing
Data type
Data cycle

The communication timing is necessary to separate the wireless power transmission and the inter-coil communication, for example, when the wireless power transmission and the inter-coil communication are shared in a time-division manner.

In FIG. 10, a communication procedure performed, for example, when the wireless power transmission and the inter-coil communication are shared in a time-division manner is shown. From FIG. 10, the communication timing indicates a period for carrying out the initial inter-coil communication after the wireless power transmission is started. According to the communication timing, both the power transmitting and receiving apparatuses independently shift to a transmission and reception mode by the inter-coil communication. The communication timing can be realized by using, for example, the number of clocks for which a time period from the start of the wireless power transmission until the inter-coil communication elapses. However, other methods may be used. By exchanging the communication timing in advance, it is possible to realize the inter-coil communication according to respective determinations in both the power transmitting and receiving apparatuses. Note that, in FIG. 10, when the power transmitting apparatus shifts from the wireless power transmission to the inter-coil communication or when the power transmitting apparatus shifts from the inter-coil communication to the wireless power transmission, the wireless power transmission and the inter-coil communication respectively have margin periods to prevent breakage of the apparatuses and the like. However, the margin periods may be omitted.

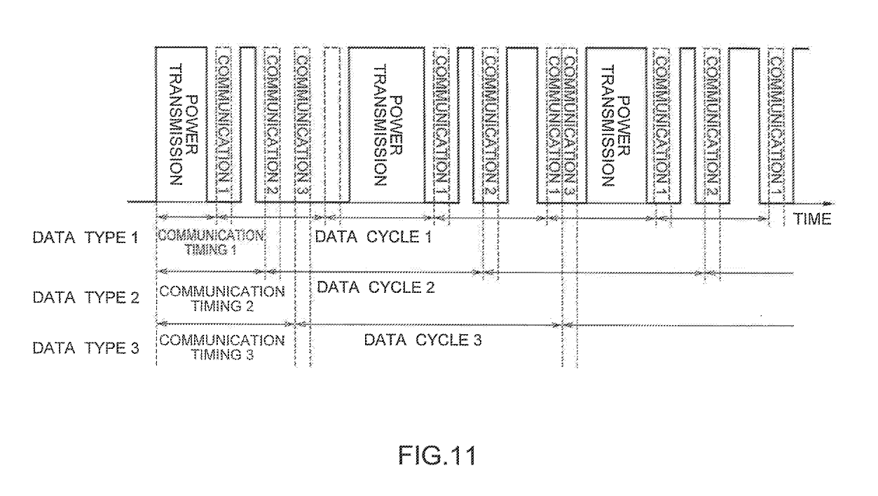

The initial inter-coil communication can be carried out according to the communication timing. However, the inter-coil communication is cyclically carried out according to a data type and a data cycle exchanged in advance. The data cycle is sometimes different depending on the data type. In that case, a plurality of data types need to be mixed and transmitted. In FIG. 10, one kind of the data type is transmitted according to the data cycle. An example of a transmission method for transmitting a plurality of kinds of data types according to data cycles is shown in FIG. 11.

When a plurality of kinds of data types having different communication timings and data cycles are simultaneously transmitted, it is necessary to perform communication according to the data cycles of the respective data types as shown in FIG. 11. Although not shown in FIG. 11, when there are calls for a plurality of data types at the same timing at a certain instance, the plurality of data types are simultaneously transmitted. The above method is an example. For example, when communication timing is the same, a plurality of kinds of data types may be treated with reference to a data cycle of the least common multiple of respective data cycles. In that case, it is necessary to allow calls for a plurality of data types at the same timing. When the wireless power transmission and the inter-coil communication are performed in a time-division manner as shown in FIG. 11, it is necessary to reduce a frequency of the inter-coil communication in order to improve transmission efficiency of the wireless power transmission. Therefore, calls for the plurality of data types are preferably performed at the same timing as much as possible. Therefore, it is preferable to adopt a method with a smallest frequency of the inter-coil communication on the basis of the communication timing and the data cycle.

Information concerning the data type and the data cycle is extremely important parameters in the interruption 1 mode. For example, the pre-power transmission information and the safety control information are included as types of data in the normal mode. In the interruption 1 mode, a data type is designated at the time of startup and only designated information is exchanged during power transmission (i.e., an information amount to be communicated is reduced; conversely, the information amount is increased in the normal mode). Consequently, it is possible to minimize resources used for communication and carry out power transmission control while minimizing deterioration in the power transmission efficiency. Note that, as data types used in the interruption 1 mode, for example, electric power, electric current, and voltage information at respective measurement points, resistance information of a load or, when the load is a battery, charging information, and the like are included. However, the data types are not limited to such information. It is possible to improve the power transmission efficiency by saving information to be communicated as much as possible. Further, at this point, the data cycle is also exchanged. Basically, any control is performed according to a certain specific cycle and communication concerning the control is cyclically performed on the basis of the cycle. In particular, in the case of the wireless power transmission apparatus, the power transmitting apparatus requests necessary data and the power receiving apparatus returns data corresponding to the request. The exchange of the data is carried out at a fixed cycle. At this point, a cycle of data and a type of the data called from the power transmitting apparatus are exchanged before the start of power transmission. Consequently, it is possible to acquire data necessary for the control from the power receiving apparatus without performing a data request from the power transmitting apparatus. In other words, it is possible to realize transmission control for the wireless power transmission according to cyclic transmission of data in one-way from the power receiving apparatus. Consequently, it is possible to reduce resources necessary for communication and improve the power transmission efficiency.

When the exchange of the pre-power transmission information and the safety control information ends, the power transmitting apparatus transmits a power transmission start notification (S308) and starts power transmission (S309). The power transmitting apparatus also performs the power transmission start notification using the communicating unit 2. The power transmitting apparatus may start the power transmission without transmitting the power transmission start notification.

Note that, in FIG. 9 and other examples, the wireless power transmission and the inter-coil communication are realized by time-division. However, various methods other than the time division can be applied. For example, if a method such as frequency division is used, it is possible to realize the inter-coil communication without deteriorating the transmission efficiency of the wireless power transmission. Even when load modulated communication is applied, it is possible to adopt a configuration in which the communication can be performed during execution of the wireless power transmission. Various methods can be applied without departing from the above.

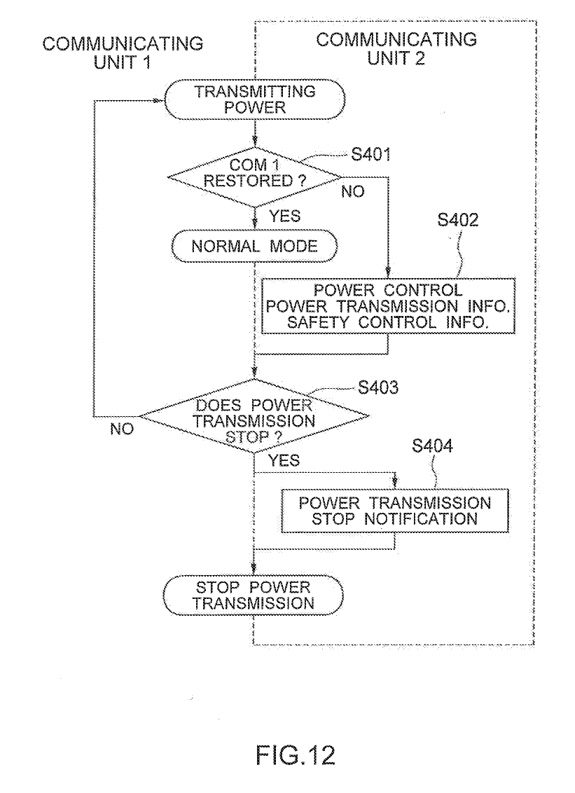

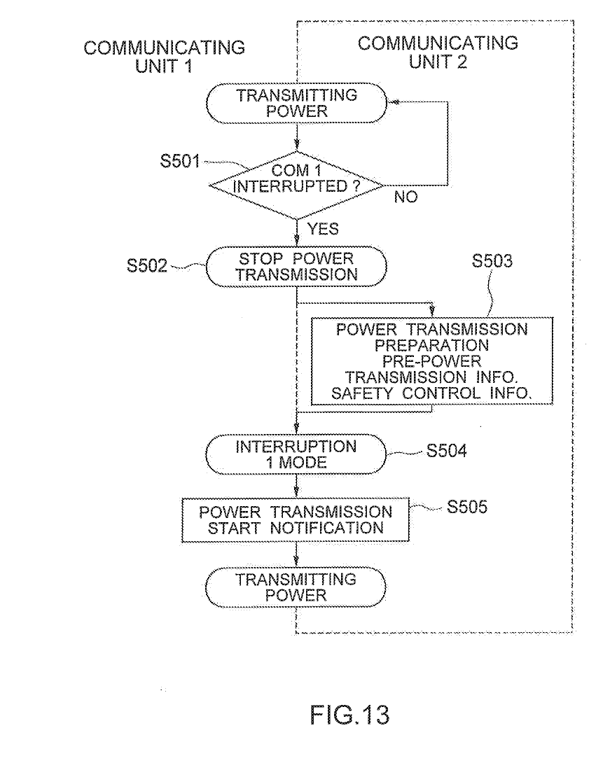

### (FIGS. 12 and 13: A Flowchart During Power Transmission in the Interruption 1 Mode (the State 2))

A flowchart during power transmission of the wireless power transmission in the interruption 1 mode is shown in FIG. 12. The flowchart is substantially the same as the flowchart during the power transmission in the normal mode. All communications are performed using the communicating unit 2.

The flowchart is different from that in normal mode in that, when restoration of the communicating unit 1 is detected (Yes in S401), the power transmitting apparatus switches the communicating unit to the communicating unit 1 and transitions to the normal mode. When the power transmission information and the safety control information are exchanged (S402), as explained above, the power transmitting apparatus performs exchange of the information on the basis of a data type and a data cycle exchanged before the start of power transmission as explained above. Processing in steps S403 and S404 is the same as the processing in steps S202 and S203 in the normal mode shown in FIG. 8.

An example of a procedure in the case of transitioning from another state to the interruption 1 mode during power transmission is shown in FIG. 13. When the communicating unit 1 is interrupted during power transmission (Yes in S501), the interrupt of the communicating unit 1 can be determined by the power transmitting apparatus only as well. Therefore, first, the power transmitting apparatus stops the power transmission for safety (S502). Thereafter, the power transmitting apparatus performs exchange of pre-power transmission information and safety control information using the communicating unit 2 (S503). At this point, communication timing, a data type, and a data cycle are included in the pre-power transmission information. After the exchange of the pre-power transmission information, the power transmitting apparatus transitions to the interruption 1 mode (S504). The power transmitting apparatus transmits a power transmission start notification (S505) and starts power transmission. In that case, transmission control is executed on the basis of communication timing, data type, and data cycle information exchanged beforehand. Note that the above is an example. Other methods can be used without departing from the above. When the inter-coil communication is performed as the communicating unit 2, for example, when a method that can realize the inter-coil communication while continuing the wireless power transmission such as frequency division is used, the power transmitting apparatus does not stop the power transmission in step S502. The power transmitting apparatus may exchange the pre-transmission information and the safety control information in step S503 while continuing the wireless power transmission.

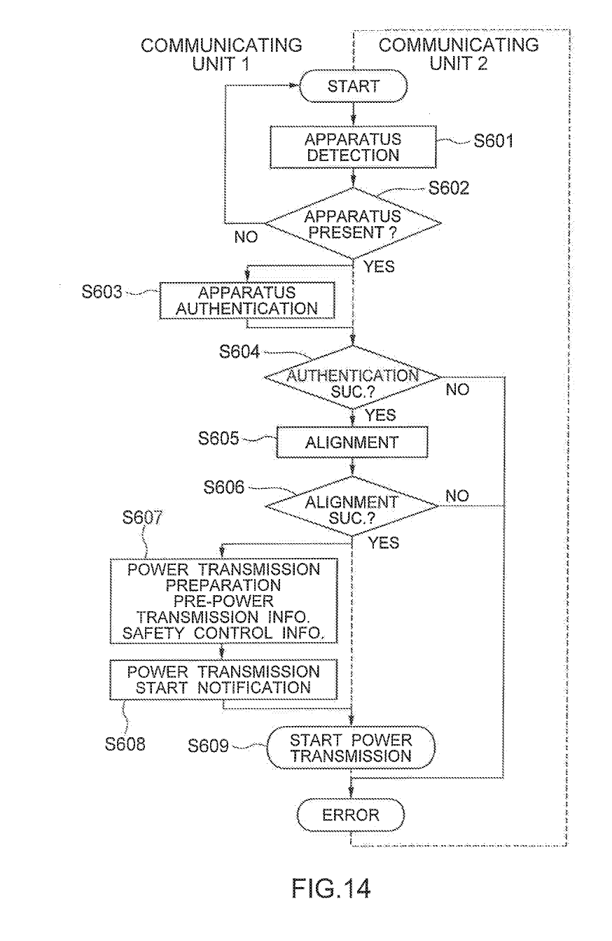

### (FIG. 14: A Flowchart at the Time of Startup in the Interruption 2 Mode (the State 3))

A flowchart at the time of startup of the wireless power transmission in the interruption 2 mode is shown in FIG. 14. The interruption 2 mode is a state in which communication by the communicating unit 2 is interrupted in a short term or a long term. Examples of a method of determining that communication is interrupted include a method of counting the number of times timeout of communication and a data loss occur and determining the counted number of times with respect to a threshold, and more specifically, include a method of determining that communication is interrupted if the timeout and the data loss continuously occur several times and a method of setting upper limits of the number of times of the timeout and the data loss and determining that communication is interrupted if the timeout and the data loss exceed the upper limits in a fixed time. Various methods of determining the interruption can be applied without departing from the above-mentioned methods.

As a first procedure, the power transmitting apparatus performs apparatus detection for searching for a power receiving apparatus (S601). For the apparatus detection, the communicating unit 1 may be used or a sensor, a camera, or a separate communication apparatus may be used. If a power receiving apparatus is found (Yes in S602), the power transmitting apparatus shifts to the next procedure. If a power receiving apparatus is not found (No in S602), the power transmitting apparatus repeats the apparatus detection. The apparatus detection may be always performed or may be cyclically performed. When the apparatus detection is cyclically performed, consumed power can be reduced compared with power consumed when the apparatus detection is always performed.

When a power receiving apparatus is detected by the apparatus detection, the power transmitting apparatus performs authentication of the power receiving apparatus in order to determine whether the power receiving apparatus is a malicious apparatus having a purpose of a power theft or a obstacle (S603). The apparatus authentication is performed using the communicating unit 1. When the communicating unit 2 is used, since the communicating unit 2 has a communicable range wider than a communicable range of the communicating unit 1, there are risks of wiretapping and piracy. Therefore, firm security measures may be taken according to necessity. Not that, rather than transitioning to the error state when the apparatus authentication is unsuccessful once, the power transmitting apparatus may transition to the error state when the apparatus authentication is continuously unsuccessful a plurality of times. The power transmitting apparatus may perform the apparatus authentication simultaneously with the apparatus detection or before the apparatus detection.

Note that it can be determined whether the communicating unit 2 is interrupted only when communication is performed by the communicating unit 2 in the apparatus authentication unless the communicating unit 2 is used for the apparatus detection. Therefore, the power transmitting apparatus transitions to the interruption 2 mode at the first stage of the use of the communicating unit 2.

When the apparatus authentication ends (Yes in S604), the power transmitting apparatus performs alignment (S605). For the alignment, the communicating unit 1 may be used. Any method of aligning a position using an apparatus other than the communicating unit 2 such as a sensor, a camera, or a separate communication apparatus can be applied. Note that the alignment could be sometimes unnecessary depending on an application to be applied. For example, when a setting position of the power receiving apparatus is explicitly marked in a power transmitting apparatus main body and a user arranges the power receiving apparatus in the setting position, communication is unnecessary and the user performs the alignment. When the alignment is performed, it is also possible to perform calibration necessary at the time of start of power transmission.

When the alignment ends (Yes in S606), subsequently, the power transmitting apparatus exchanges pre-power transmission information and safety control information necessary at the time of start of power transmission (S607). The information is transmitted using the communicating unit 1. At this point, in the interruption 2 mode, information for notifying the power receiving apparatus that the communicating unit 2 is interrupted may be added.

When the exchange of the pre-power transmission information and the safety control information ends, the power transmitting apparatus transmits a power transmission start notification using the communicating unit 1 (S608) and starts power transmission (S609). The power transmitting apparatus may start the power transmission without transmitting the power transmission start notification.

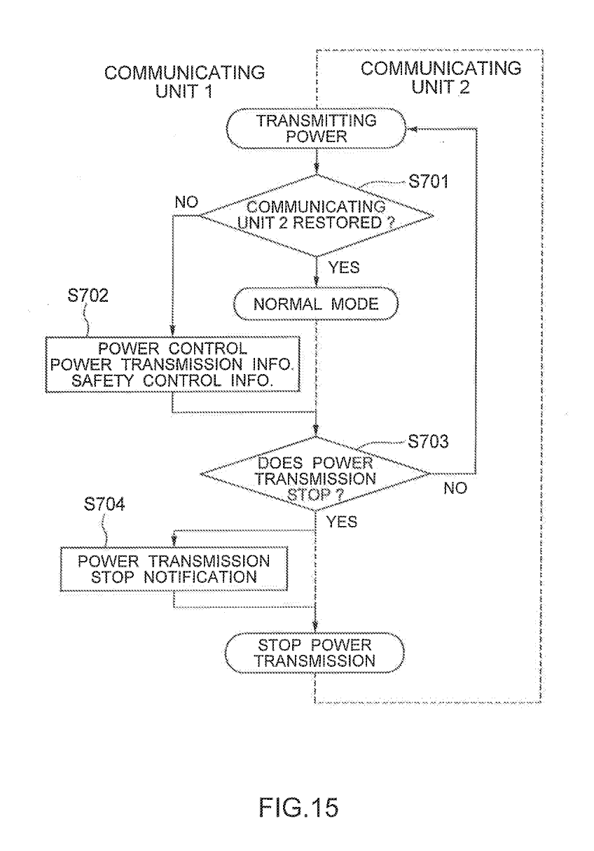

### (FIG. 15: A Flowchart During Power Transmission in the Interruption 2 Mode (the State 3))

A flowchart during power transmission of the wireless power transmission in the interruption 2 mode is shown in FIG. 15. The flowchart is substantially the same as the flowchart during power transmission in the normal mode. When restoration of the communicating unit 2 is detected (Yes in S701), the power transmitting apparatus transitions to the normal mode. However, since switching of the communicating unit is not performed, a significant change does not occur. Processing in steps S702, S703, and S704 is the same as the processing in steps S201, S202, and S203 of the normal mode shown in FIG. 8.

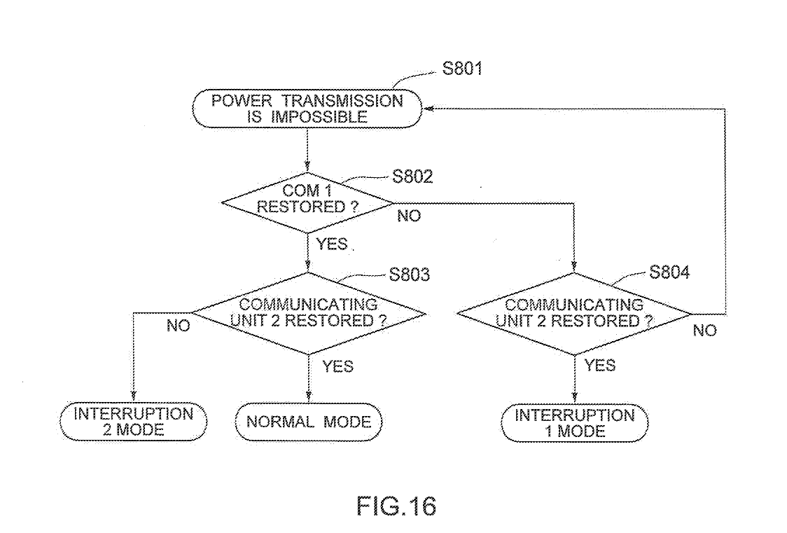

### (FIG. 16: Operation at the Time of Startup and During Power Transmission in the Full Interruption Mode)

When both of the communicating unit 1 and the communicating unit 2 are interrupted, the power transmitting apparatus transitions to the full interruption mode. In this full interruption mode, irrespective of whether the power transmission is started up or being performed, the power transmitting apparatus determines that the power transmitting apparatus is in a power transmission impossible state (S801) and does not perform the wireless power transmission. In this mode, the control unit repeatedly performs a check of communication restoration in both of the communicating unit 1 and the communicating unit 2 (S802, S803, and S804). When any one of or both of the communicating unit 1 and the communicating unit 2 are restored, the power transmitting apparatus transitions to the respective modes (interruption 2, normal, and interruption 1) and performs startup processing or power transmission.

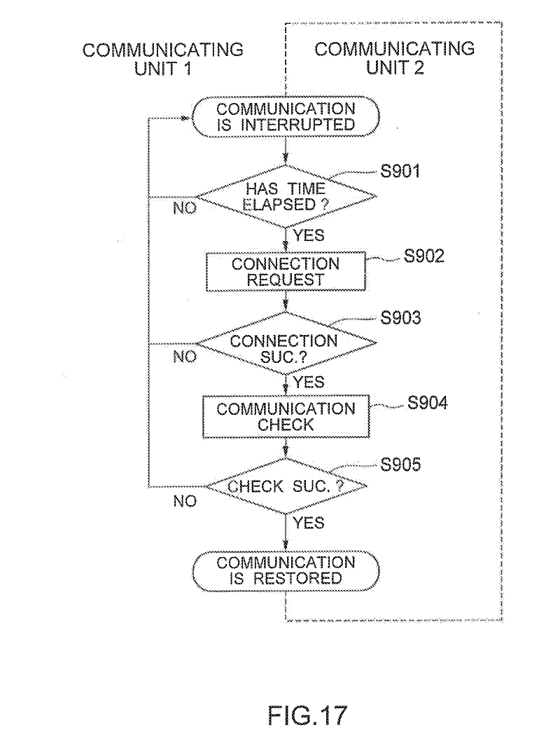

### (FIG. 17: A Flowchart Until Communication Restoration at the Time of Interruption of the Communicating Unit 1 and the Communicating Unit 2 in the Interruption 1 Mode, the Interruption 2 Mode, and the Full Interruption Mode)

A flowchart until communication restoration in the communicating unit 1 and the communicating unit 2 currently being interrupted in the interruption 1 mode, the interruption 2 mode, and the full interruption mode is shown in FIG. 17. A flow is the same in the communicating unit 1 and the communicating unit 2.

When communication is interrupted in the communicating unit 1 and the communicating unit 2, it is necessary to cyclically check restoration of the communication. Therefore, the elapse of time is counted (S901), and after a fixed time elapses (Yes in S901), the power transmitting apparatus performs a connection request (S902). The connection request indicates, for example, when Bluetooth is used as the communicating unit 1, Page Scan, Inquiry Scan, Page, or Inquiry, and indicates that, for example, when wireless LAN is used, exchange of an authentication key after a check of an SSID is performed. When the connection is successful (Yes in S903), the power transmitting apparatus performs a communication check for a reliability check for communication (S904). When the connection is unsuccessful (No in S903), the power transmitting apparatus stays on standby in a communication interrupted state until the next elapse of time again. Note that, when the communicating unit 2 is interrupted, the power transmitting apparatus may first perform a communication check, which is the next flow, without performing the connection request.

Examples of a communication check method performed when connection is successful include a method of actually performing data communication a plurality of times using the communicating unit 1 and the communicating unit 2 and counting the number of times of communication success. If the number of times of communication success is equal to or larger than a threshold, the power transmitting apparatus determines that reliability of communication can be secured (Yes in S905) and determines that the communicating unit 1 and the communicating unit 2 are restored. The communication is performed a plurality of times because if the communication is performed only once or a few times, it is determined that the communication is restored even when the communication is accidentally successful, and actually, it is likely that a communication environment is extremely unstable because of interference and noise. To prevent this state, a certain threshold is provided to determine restoration of the communication. The threshold can be arbitrarily set according to each system. Note that the above method is desirable as a method of checking the reliability of communication. However, the method is not limited to the above method and other methods can be applied.

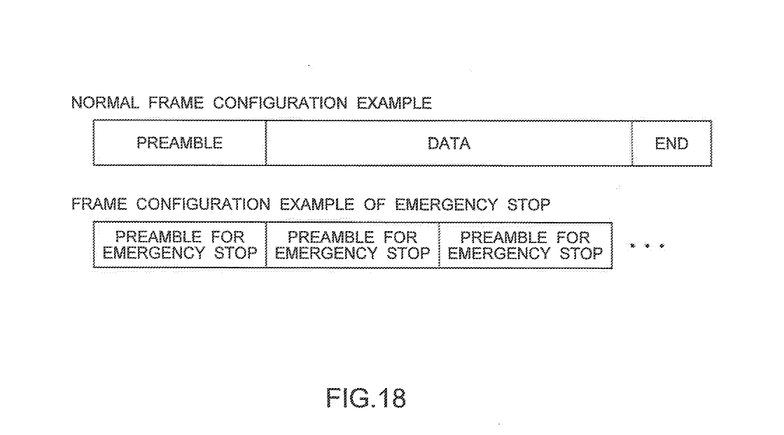

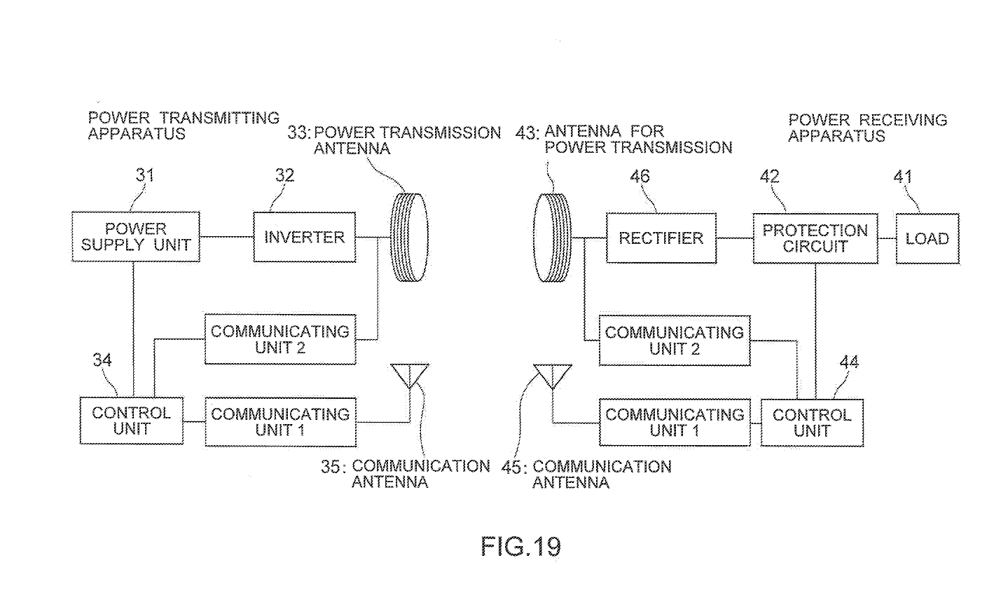

### (FIGS. 18 and 19: An Operation Example of the Communicating Unit 2 at the Time of an Emergency Stop)

In the power transmitting apparatus for wireless power transmission according to the embodiment, in a state in which power transmission needs to be immediately emergently stopped because of an anomaly such as heat generation of the power receiving apparatus, breakage of an apparatus, overvoltage, overcurrent, or the like, it is necessary to perform radio communication in order to notify that the power transmission is emergently stopped. At this point, when the emergency stop of the power supply is notified using the communicating unit 1 in which a general communication standard such as wireless LAN or Bluetooth is used, since a delay is caused by processing in respective protocols or processing by an access control unit such as a MAC layer, it is extremely difficult to satisfy a delay time allowed until the emergency stop. Therefore, in this proposal, when the emergency stop is immediately necessary, an emergency stop signal, which is an example of an anomaly notification signal, is exchanged using the communicating unit 2 in both the normal mode and the interruption 1 mode unless the communicating unit 2 is interrupted. When the communicating unit 2 is used, it is easy to change the configuration of a frame. For example, if a preamble for emergency stop including a code different from a preamble part usually used in the communicating unit 2 is used as a preamble part of a frame as shown in FIG. 18, it is possible to stop the power transmission when the preamble part is received. Further, since the preamble for emergency stop is repeatedly transmitted without including a data part until the power transmission is stopped, it is possible to improve a reception success probability of the preamble for emergency stop.

Rather than using the preamble for emergency stop, it may be regarded that the emergency stop signal is received by the protecting operation for the power transmitting apparatus, the operation of a protection circuit 42 included in the power receiving apparatus in a wireless power transmission system shown in FIG. 19. The power receiving apparatus sometimes includes the protection circuit 42 for preventing overcurrent and overvoltage to a load 41. The protection circuit 42 performs operation for, for example, changing the load 41 to an open state to prevent electric power from being supplied to the load 41. At this point, the fluctuation of load impedance of the power receiving apparatus in view of the power transmitting apparatus side occurs. Characteristic changes of a voltage and an electric current in the power transmitting apparatus appears. By detecting the voltage and electric current fluctuations in the power transmitting apparatus, it is possible to determine that the protection circuit 42 of the power receiving apparatus operates. The communicating unit 2 in the embodiment is the inter-coil communication. The inter-coil communication is a method of communication via changes in a voltage and an electric current. Therefore, the control unit 34 on the power transmitting apparatus connected to the communicating unit 2 of this proposal can detect the protection circuit operation of the power receiving apparatus. When the control unit 34 detects the operation of the protection circuit 42, it is possible to stop power transmission. Note that changes in a voltage and an electric current on the power transmitting apparatus side at the time of the protection circuit operation are different depending on circuit topologies. Therefore, it is necessary to select an optimum method for determining the protection circuit operation according to each of the topologies.

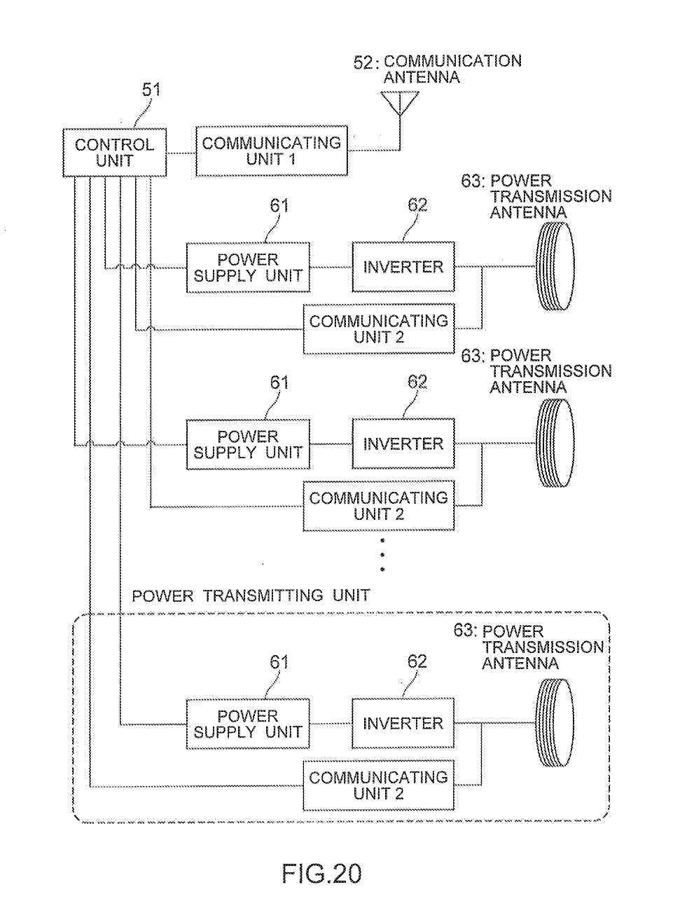

### (FIGS. 20, 21, 22, and 23: A Second Configuration Example of the Power Transmitting Apparatus for Wireless Power Transmission According to the Embodiment)

A second configuration example of the power transmitting apparatus for wireless power transmission according to the embodiment is shown in FIGS. 20 to 23. First, the power transmitting apparatus for wireless power transmission shown in FIG. 20 includes one control unit 51, one communicating unit 1, one communication antenna 52, and a plurality of power transmitting units. The power transmitting units include power supply units 61, inverters 62, communicating unit 2, and power transmission antennas 63. In FIG. 20, the power supply units 61 are provided in the respective power transmitting units. However, the power transmitting apparatus for wireless power transmission may include one power supply unit. Such a configuration is applied to a system for performing central management in a center server, for example, in a scene of use where an electric is charged for an electric vehicle by radio in a large car park. At this point, the communicating unit 1 of a centrally-managed server on the power transmission side and the communicating unit 1 of the power receiving apparatus are connected for communication in a one-to-many relation. Examples of advantages of this system include a cost reduction through a reduction in the number of the communicating unit 1 on the power transmission side and improvement of efficiency of a wireless resource through the use of a broadcast packet.

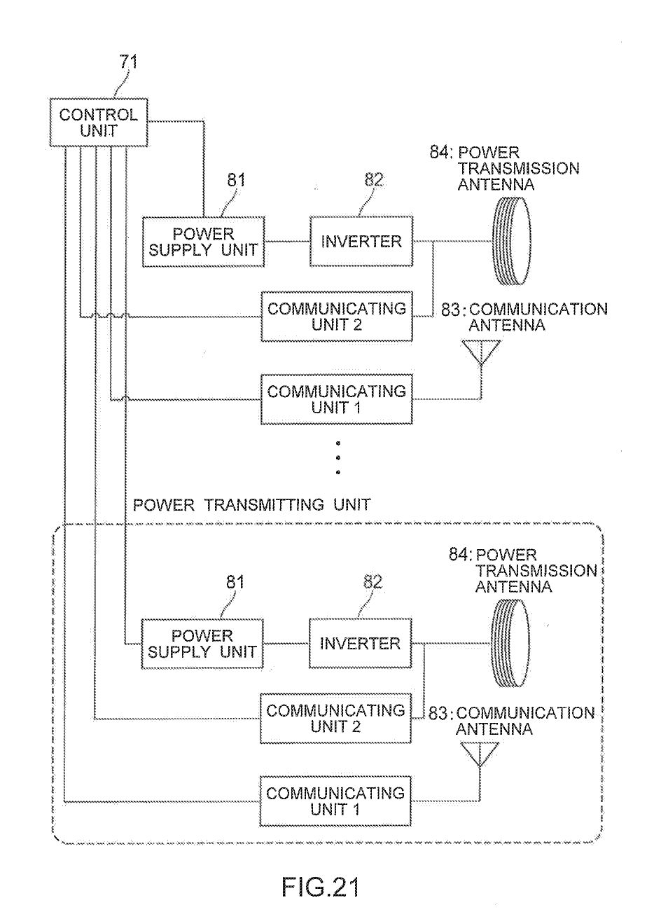

In the configuration of the power transmitting apparatus for wireless power transmission shown in FIG. 21, there are a plurality of power transmitting units including one control unit 71, one power supply unit 81, one inverter 82, one communicating unit 1, one communicating unit 2, one communication antenna 83, and one power transmission antenna 84. This configuration is different from the configuration shown in FIG. 20 in that one communicating unit 1 and one communication antenna 83 are present in each of the power transmitting units. In this configuration, the communicating unit 1 is connected to the communicating unit 1 of each of the power receiving apparatuses in a one-to-one relation. In FIG. 20, the number of connected communicating units is limited with an upper limit in a communication capacity according to a one-to-many network topology. However, in the configuration shown in FIG. 21, no problem occurs because the communicating units are connected in a one-to-one relation. However, since there are a plurality of systems in which the communicating units are connected in a one-to-one relation, the systems could be interference sources for each other.

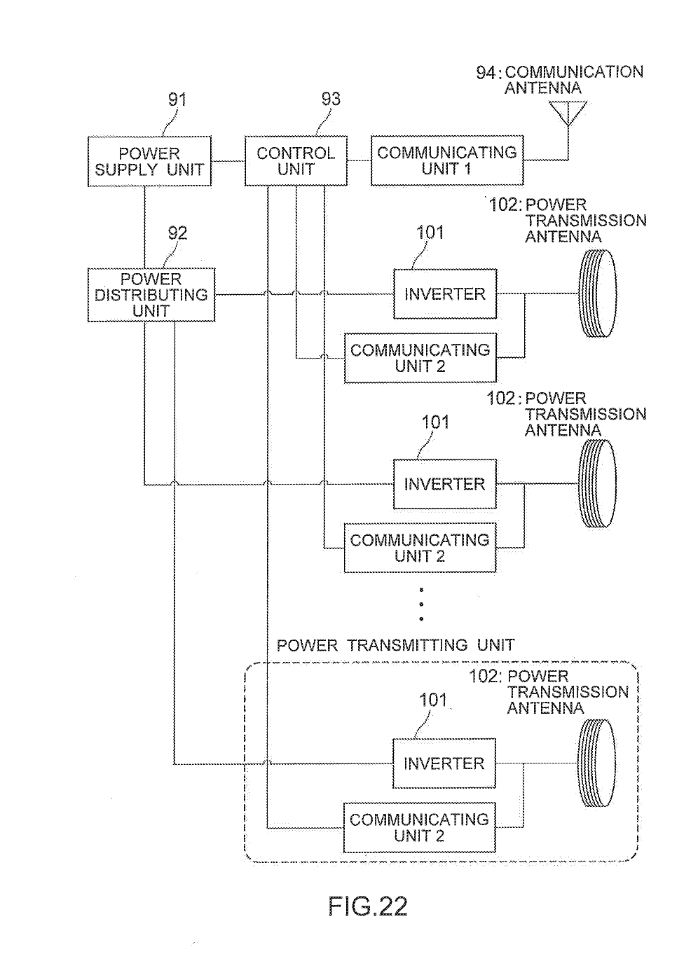

The power transmitting apparatus for wireless power transmission shown in FIG. 22 includes one power supply unit 91, one power distributing unit 92 configured to distribute electric power output from the power supply unit 91 to a plurality of power transmitting units, one control unit 93, one communicating unit 1, one communication antenna 94, and the plurality of power transmitting units. The power transmitting units include inverters 101, communicating units 2, and power transmission antennas 102. The electric power output from the power supply unit 91 is input to the respective inverters 101 of the plurality of power transmitting units through the power distributing unit 92. A control unit 103 is connected to one or both of the power supply unit 91 and the power distributing unit 92 and performs adjustment of power supply amounts to the respective power transmitting units. Note that, although one inverter is arranged in each of the power transmitting units in the configuration of FIG. 22, it is possible to reduce the number of inverters by setting the inverters between the power supply unit and the power distributing unit.

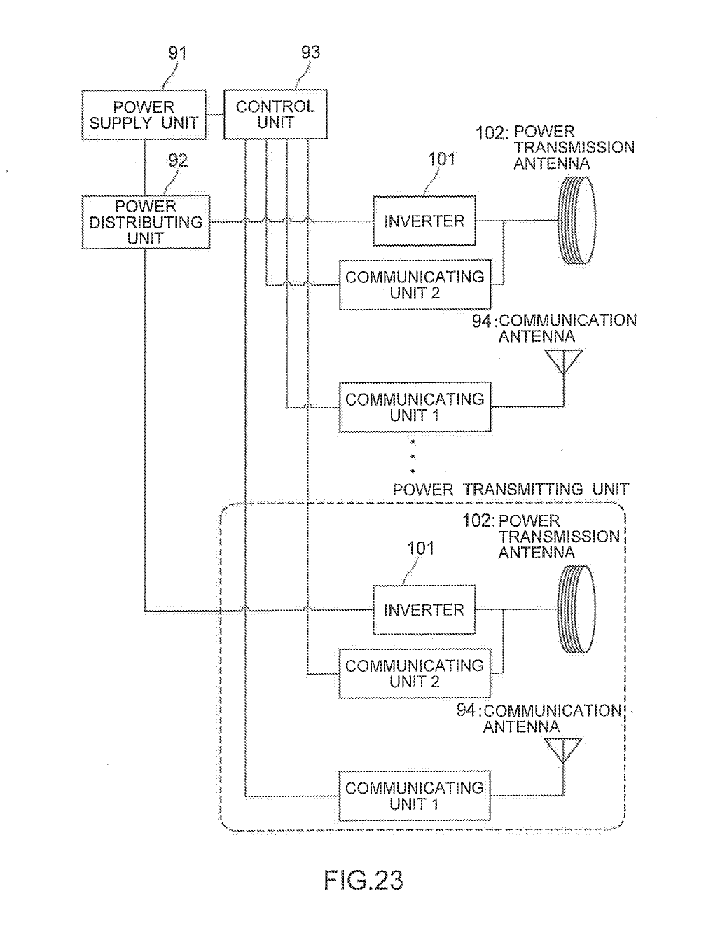

The configuration of the power transmitting apparatus for wireless power transmission shown in FIG. 23 is a configuration in which one communicating unit 1 and one communication antenna 94 are arranged in each of the power transmitting units in the configuration shown in FIG. 22. In FIG. 23, there is an advantage that control in the respective power transmitting units can be performed at higher speed compared with the configuration shown in FIG. 22. In the configuration shown in FIG. 23, one inverter is arranged in each of the power transmitting units. However, it is also possible to reduce the number of inverters by setting the inverters between the power supply unit and the power distributing unit.

### (Second Operation Example of the Power Transmitting Apparatus for Wireless Power Transmission According to the Embodiment)

A second operation example in a second configuration example of the power transmitting apparatus for wireless power transmission according to the embodiment is explained. In the second configuration example, as in the first operation example, control flows different from one another are applied in the four states specified in FIG. 5. Since the operations of the respective flows are the same as the flows in the first operation example, explanation of the operations is omitted. The second configuration example is different from the first operation example in that power transmission to a plurality of power receiving apparatuses is possible or, since use in a commercial facility or the like is assumed, accounting information and supplied power amount information are exchanged in the communicating unit 1 and the communicating unit 2.

For example, in the case of the normal mode, various kinds of setting are performed in the flow shown in FIG. 6. Accounting information and supplied power amount information are exchanged before a power transmission start notification. In the normal mode and the interruption 2 mode, these kinds of information are exchanged using the communicating unit 1. However, in the case of the interruption 1 mode, these kinds of information are exchanged using the communicating unit 2. In the normal mode, since it is necessary to use communicating unit with high confidentiality, in particular, for accounting information, the communicating unit 2 may be used.

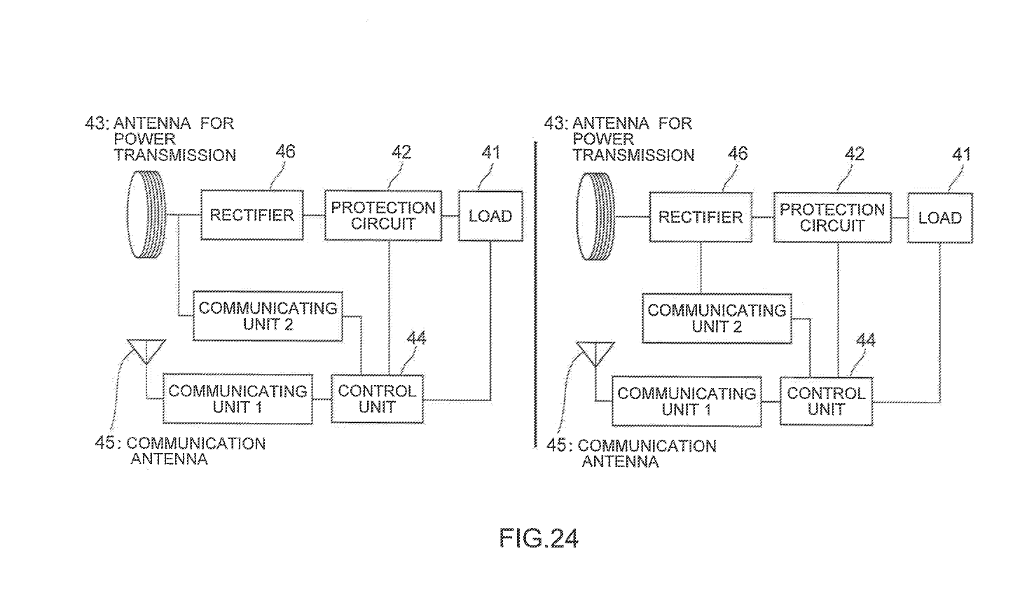

### (FIG. 24: A First Configuration Example of a Power Receiving Apparatus for Wireless Power Transmission According to the Embodiment)

FIG. 24 shows a first configuration example of a power receiving apparatus for wireless power transmission according to the embodiment. According to FIG. 24, the power receiving apparatus includes the load 41 to which electric power is supplied by radio, the protection circuit 42 configured to monitor the electric power supplied to the load and prevent overvoltage and overcurrent, a rectifier 46, an antenna for power transmission 43, a control unit 44 configured to perform control of power transmission, a communication antenna 45 used for collecting parameters necessary for the control of the power transmission in the control unit, the communicating unit 1 connected to the communication antenna 45, and the communicating unit 2 connected to the antenna for power transmission 43. The control unit 44 selects at least one of the communicating unit 1 and the communicating unit 2 and exchanges the parameters necessary for the control of the power transmission with the power transmitting apparatus. The control unit 44 includes a measuring unit configured to measure communication quality between the communicating unit 1 and the power transmitting apparatus (first communication quality) and communication quality between the communicating unit 2 and the power transmitting apparatus (second communication quality). When the first communication quality is lower than a first standard, the control unit 44 determines that communication between the communicating unit 1 and the power transmitting apparatus is in an interrupted state. When the first communication quality is equal to or higher than the first standard, the control unit 44 determines that the communication is in a link stable state. When the second communication quality is lower than a second standard, the control unit 44 determines that communication between the communicating unit 2 and the power transmitting apparatus is in an interrupted state. When the second communication quality is equal to or higher than the second standard, the control unit 44 determines that the communication is in a link stable state.

A difference between the left diagram and the right diagram of FIG. 24 is whether the communicating unit 2 is connected to the antenna for power transmission 43 or connected to the rectifier 46.

Load modulation (backscatter modulation) that is used for RFID and the wireless power transmission system for small power devices, can be applied to the communicating unit 2. In this case, a load modulation circuit for performing the load modulation may be connected to either the front or the back of the rectifier. Although not shown in FIG. 24, a converter may be connected between the rectifier 46 and the protection circuit 42. The communicating unit 2 can be connected to either the front or the back of the converter,

### (First Operation Example of the Power Receiving Apparatus for Wireless Power Transmission According to the Embodiment)

A first operation example of the embodiment in the first configuration example is explained. In the first operation example, the power receiving apparatus transitions to any one of the states shown in FIG. 5 as in the first operation example of the power transmitting apparatus. Operation procedures are different in the respective states. Excerpts from FIG. 5 are as described below.

State 1 (normal mode): communicating unit 1=link stable communicating unit 2=link stable

State 2 (interruption 1 mode): communicating unit 1=interrupted communicating unit 2=link stable

State 3 (interruption 2 mode): communicating unit 1=link stable communicating unit 2=interrupted

State 4 (full interruption mode): communicating unit 1=interrupted communicating unit 2=interrupted

Operation procedures in the respective states are the same as the operation procedures in the first operation example of the power transmitting apparatus. Therefore, explanation of the operation procedures is omitted.

### (Operation Example of the Communicating Unit 2 During an Emergency Stop)

In the power receiving apparatus for wireless power transmission according to the embodiment, in a state in which power transmission needs to be immediately emergently stopped because of heat generation of the power receiving apparatus, breakage of an apparatus, overvoltage, overcurrent, or the like, it is necessary to perform radio communication in order to notify that the power transmission is emergently stopped. At this point, when the emergency stop of the power supply is notified using the communicating unit 1 in which a general communication standard such as wireless LAN or Bluetooth is used, since a delay is caused by processing in respective protocols or processing by an access control unit such as a MAC layer, it is extremely difficult to satisfy a delay time allowed until the emergency stop. Therefore, in this proposal, when the emergency stop is immediately necessary, an emergency stop signal is exchanged using the communicating unit 2 in both the normal mode and the interruption 1 mode unless the communicating unit 2 is interrupted. When the communicating unit 2 is used, it is easy to change the configuration of a frame. For example, if a preamble for emergency stop including a code different from a preamble part usually used in the communicating unit 2 is used as a preamble part of a frame as shown in FIG. 18, it is possible to stop the power transmission when the preamble part is received. Further, since the preamble for emergency stop is repeatedly transmitted without including a data part until the power transmission is stopped, it is possible to improve a reception success probability of the preamble for emergency stop.

Rather than using the preamble for emergency stop, the protection circuit 42 included in the power receiving apparatus in the wireless power transmission system shown in FIG. 19 may be actuated to transmit the emergency stop signal. The protection circuit 42 performs operation for, for example, changing the load 41 to an open state to prevent electric power from being supplied to the load 41. At this point, the fluctuation of load impedance of the power receiving apparatus in view of the power transmitting apparatus side occurs. Characteristic changes of a voltage and an electric current in the power transmitting apparatus appears. By detecting the voltage and electric current fluctuations in the power transmitting apparatus, it is possible to determine that the protection circuit 42 of the power receiving apparatus operates. The communicating unit 2 in the embodiment is the inter-coil communication. The inter-coil communication is a method of communication via changes in a voltage and an electric current. Therefore, the control unit 34 connected to the communicating unit 2 of this proposal can detect a protection circuit operation of the power receiving apparatus. When the control unit 34 detects the operation of the protection circuit 42, it is possible to stop power transmission.

Note that changes in a voltage and an electric current on the power transmitting apparatus side at the time of the protection circuit operation are different depending on circuit topologies. Therefore, it is necessary to select an optimum method for determining the protection circuit operation according to each of the topologies. Note that examples of a place where the voltage and electric current changes are measured on the power transmitting apparatus side of the protection circuit operation include a place between the power transmission antenna and the inverter, a place between the power distributing unit and the inverter, and a place between the power supply unit and the inverter. However, besides these places, the place for measuring the voltage and electric current changes may be any place where the protection circuit operation is possible to obtain these changes in the power transmitting apparatus.

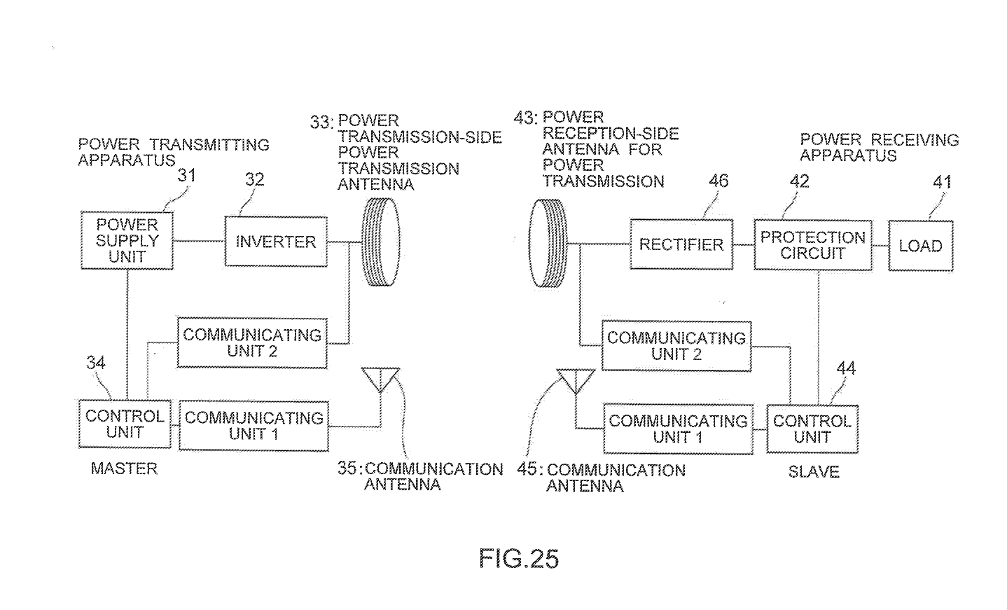

### (FIG. 25: A First Configuration Example of the Wireless Power Transmission System According to the Embodiment)

A first configuration example of the wireless power transmission system according to the embodiment is shown in FIG. 25. According to FIG. 25, the wireless power transmission system according to the embodiment includes a power transmitting apparatus and a power receiving apparatus. The power transmitting apparatus includes the power supply unit 31 functioning as a power supply, the inverter 32 for conversion into predetermined electric power, electric current, voltage, and frequency, the power transmission-side power transmission antenna 33, the control unit 34 configured to perform control of power transmission, the power transmission-side communication antenna 35 used for collecting parameters necessary for the control of the power transmission in the control unit 34, the power transmission-side communicating unit 1 connected to the power transmission-side communication antenna 35, and the power transmission-side communicating unit 2 connected to the power transmission-side power transmission antenna. The power receiving apparatus includes the load 41 to which electric power is supplied by radio, the protection circuit 42 configured to monitor the electric power supplied to the load 41 and prevent overvoltage and overcurrent, the rectifier 46, the power reception-side antenna for power transmission 43, the power reception-side control unit 44 configured to perform control of power transmission, the power reception-side communication antenna 45 used for collecting parameters necessary for the control of the power transmission in the power reception-side control unit 44, the power reception-side communicating unit 1 connected to the power reception-side communication antenna, and the power reception-side communicating unit 2 connected to the power reception-side antenna for power transmission.

The power transmission-side control unit 34 selects at least one of the power transmission-side communicating unit 1 and the power transmission-side communicating unit 2 and exchanges parameters necessary for control of the wireless power transmission with the power receiving apparatus. Similarly, the power reception-side control unit 44 selects at least one of the power reception-side communicating unit 1 and the power reception-side communicating unit 2 and exchanges parameters necessary for control of the wireless power transmission with the power transmitting apparatus. Load modulation (backscatter modulation) that is used for RFID and the wireless power transmission system for small power devices, can be applied to the power transmission-side communicating unit 2 and the power reception-side communicating unit 2. In this case, in the power transmitting apparatus, the load modulation can be applied to either of the front or the back of the inverter. In the power receiving apparatus, the load modulation can be applied to either of the front or the back of the converter. In the power transmitting apparatus, irrespective of the application of the load modulation, it is also possible to directly connect the inverter and generate a signal using a switch of the inverter. In the power receiving apparatus, the converter may be connected between the rectifier 41 and the protection circuit 42.

In the first configuration example of the wireless power transmission system according to the embodiment, the power transmission-side control unit 34 of the power transmitting apparatus functions as a master and executes various kinds of control for the wireless power transmission and control performed when the power transmission-side and power reception-side communicating units 1 and 2 are interrupted. The power reception-side control unit 44 of the power receiving apparatus functions as a slave and receives a command of the power transmission-side control unit 34 and operates.

### (FIGS. 4A, 4B and 5: A First Operation Example of the Wireless Power Transmission System According to the Embodiment)

First, a list of control items in the wireless power transmission system according to the embodiment is shown in FIGS. 4A and 46. The wireless power transmission system according to the embodiment needs to carry out several control items among the items shown in FIGS. 4A and 4B. For example, in the case of a system that starts power transmission when a user sets the power receiving apparatus in a power transmittable range, position detection and alignment are unnecessary because the user performs the position detection and the alignment. The order for carrying out the control items can be flexibly changed according to an application and a system to which the control items are applied.

A first operation example of the embodiment in the first configuration example of the wireless power transmission system according to the embodiment is explained. In the first operation example, the wireless power transmission system transitions to any one of the states shown in FIG. 5. Operation procedures are different in the respective states. Excerpts from FIG. 5 are as described below.

State 1 (normal mode): communicating unit 1=link stable communicating unit 2=link stable

State 2 (interruption 1 mode): communicating unit 1=interrupted communicating unit 2=link stable

State 3 (interruption 2 mode): communicating unit 1=link stable communicating unit 2=interrupted

State 4 (full interruption mode): communicating unit 1=interrupted communicating unit 2=interrupted Operation procedures in the respective states are shown in the figures.

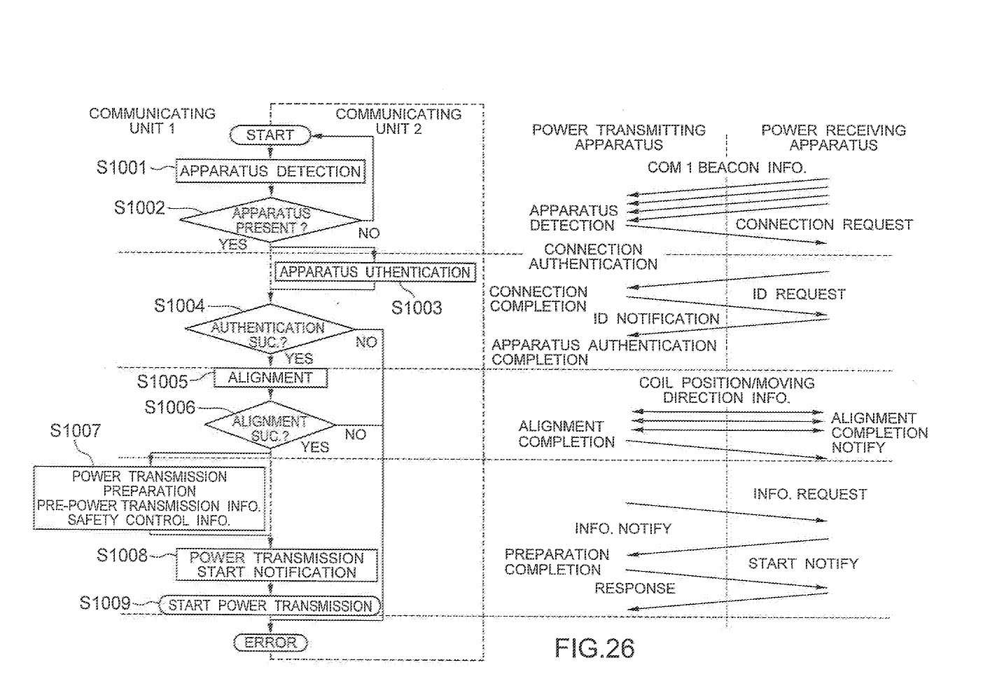

### (FIG. 26: A Flowchart and a Communication Procedure at the Time of Startup in the Normal Mode (the State 1) of the Wireless Power Transmission System According to the Embodiment)

An example of a flowchart and a communication procedure at the time of startup of wireless power transmission in the normal mode of the wireless power transmission system according to the present embodiment is shown in FIG. 26. A flow shown in FIG. 26 is explained in order. In FIG. 26, apparatus detection, apparatus authentication, alignment, and power transmission preparation are carried out in this order. Besides, power transmission necessity determination, obstacle detection/obstacle removal, load information collection, and the like may be carried out. The procedures shown in FIG. 26 may be interchanged. For example, the alignment and the apparatus authentication may be interchanged. Note that, in the following explanation, when both of the power transmission-side communicating unit 1 and the power reception-side communicating unit 2 are indicated or the power transmission-side communicating unit 1 and the power reception-side communicating unit 2 are not specifically distinguished, the power transmission-side communicating unit 1 is described, and when both of the power transmission-side communicating unit 2 and the power reception-side communicating unit 2 are indicated or the power transmission-side communicating unit 2 and the power reception-side communicating unit 2 are not specifically distinguished, the power transmission-side communicating unit 2 is described.

As the first procedure, the wireless power transmission system performs apparatus detection for searching for a power receiving apparatus (S1001). For the apparatus detection, the communicating unit 1 may be used or the communicating unit 2 may be used. An advantage of performing the apparatus detection using the communicating unit 1 is that, for example, it is possible to detect a target power receiving apparatus from a relatively wide range compared with the communicating unit 2. However, for the detection of a power receiving apparatus, it is necessary to always supply electric power to the communicating unit 1. Therefore, there is a disadvantage that consumed power increases. An advantage of performing the apparatus detection using the communicating unit 2 is that, for example, in particular, it is possible to reduce consumed power on a power receiving apparatus side. However, as explained above, the communicating unit 2 has an extremely narrow communicable range, there is a disadvantage that an apparatus detectable range is narrow. If a power receiving apparatus is found (Yes in S1002), the wireless power transmission system shifts to the next procedure. If a power receiving apparatus is not found (No in S1002), the wireless power transmission system repeats the apparatus detection. The apparatus detection may be always performed or may be cyclically performed. When the apparatus detection is cyclically performed, consumed power can be reduced compared with power consumed when the apparatus detection is always performed. Note that the apparatus detection may be performed by means other than the communicating unit 1 and the communicating unit 2. For example, a sensor, a camera, or a separate communication apparatus may be used. In FIG. 26, an example of the apparatus detection performed using the communicating unit 1 is shown. When the communicating unit 1 is used, the power receiving apparatus transmits communicating unit 1 beacon information. When the power transmission-side communicating unit 1 of the power transmitting apparatus receives the communicating unit 1 beacon information, it is possible to determine that the apparatus is detected. For example, when a wireless LAN is used as the power transmission-side communicating unit 1 and the power reception-side communicating unit 2, a signal from the wireless LAN corresponds to a beacon signal. The wireless power transmission system reads an SSID from the received beacon, and when the SSID is a unique SSID for the wireless power transmission system, the wireless power transmission system transitions to the next state.

When a power receiving apparatus is detected by the apparatus detection, the wireless power transmission system performs authentication of the power receiving apparatus in order to determine whether the power receiving apparatus is a malicious apparatus having a purpose of a power theft or a obstacle (S1003). As the apparatus authentication, because of an advantage that a communicable range is limited when the communicating unit 2 is used, it is possible to perform authentication with high confidentiality. When the apparatus authentication is successful (Yes in S1004), the wireless power transmission system shifts to the next procedure. When the apparatus authentication is unsuccessful (No in S1004), the wireless power transmission system transitions to an error state. Rather than transitioning to the error state when the apparatus authentication is unsuccessful once, the wireless power transmission system may transition to the error state when the apparatus authentication is continuously unsuccessful a plurality of times. The wireless power transmission system may perform the apparatus authentication simultaneously with the apparatus detection or before the apparatus detection. In FIG. 26, the power transmitting apparatus transmits an ID request for the apparatus detection and the power receiving apparatus transmits an ID as a response to the ID request.

When the apparatus authentication ends, the wireless power transmission system performs alignment (S1005). The alignment is a procedure for correcting a positional relation between the power transmitting apparatus and the power receiving apparatus for improving power transmission efficiency. When a power transmission characteristic acquired in the communicating unit 2 is used for the alignment, it is desirable to use the communicating unit 2. However, the alignment can be realized by the communicating unit 1 as well. The alignment could be sometimes unnecessary depending on an application to be applied. For example, when a setting position of the power receiving apparatus is explicitly marked in a power transmitting apparatus main body and a user arranges the power receiving apparatus in the setting position, communication is unnecessary and the user performs the alignment. The order of the alignment may be interchanged with the order of the apparatus detection and the apparatus authentication performed at the pre-stage of the alignment. When the alignment is successful, the wireless power transmission system shifts to the next procedure. When the alignment is unsuccessful, the wireless power transmission system transitions to the error state. Note that as a method of determining that the alignment is unsuccessful, it is possible to apply a method of setting time length from the start of the alignment as a threshold and determining that the alignment is unsuccessful if the alignment cannot be successfully performed for a fixed time or longer. Other determining methods may be used. There is also a method of performing the alignment using the communicating unit 1 or 2. A sensor, a camera, a separate communication apparatus, or the like may be used. Any method can be applied. When the alignment is performed, it is also possible to perform calibration necessary at the time of start of power transmission. In FIG. 26, information exchanged when the alignment is performed includes coil position information, moving direction information, and an alignment completion notification.

When the alignment ends (yes in S1006), subsequently, as power transmission preparation, the wireless power transmission system exchanges pre-power transmission information and safety control information necessary at the time of start of power transmission (S1007). The information is transmitted using the communicating unit 1. In general, the communicating unit 1 has a higher transmission rate compared with the communicating unit 2. Therefore, when the communicating unit 1 is used, the wireless power transmission system can shift to the start of power transmission more quickly than when the communicating unit 2 is used.

When the exchange of the pre-power transmission information and the safety control information ends, the wireless power transmission system transmits a power transmission start notification (S1008) and starts power transmission (S1009). The wireless power transmission system may transmit the power transmission start notification using either of the communicating unit 1 or the communicating unit 2. The wireless power transmission system may start the power transmission without transmitting the power transmission start notification.

Note that for the position detection, the alignment, and the obstacle detection shown in FIGS. 4A and 4B, a method of using a characteristic of inter-coil communication performed as the communicating unit 2 or a transmission characteristic at the time of power transmission may be used. For example, when these characteristics are used for the alignment, a coupling strength of a power transmission coil between power transmission and reception is possible to be estimated by using any one of the electric power, a voltage, an electric current, and a frequency characteristic. Besides, it is possible to judge that the position is aligned by using the maximum/optimum value of coupling strength.

When coupling strength that enables power transmission is obvious, it is also possible to apply a method of setting the coupling strength as a threshold and aligning the position to set the coupling strength to be equal to or higher than the threshold.

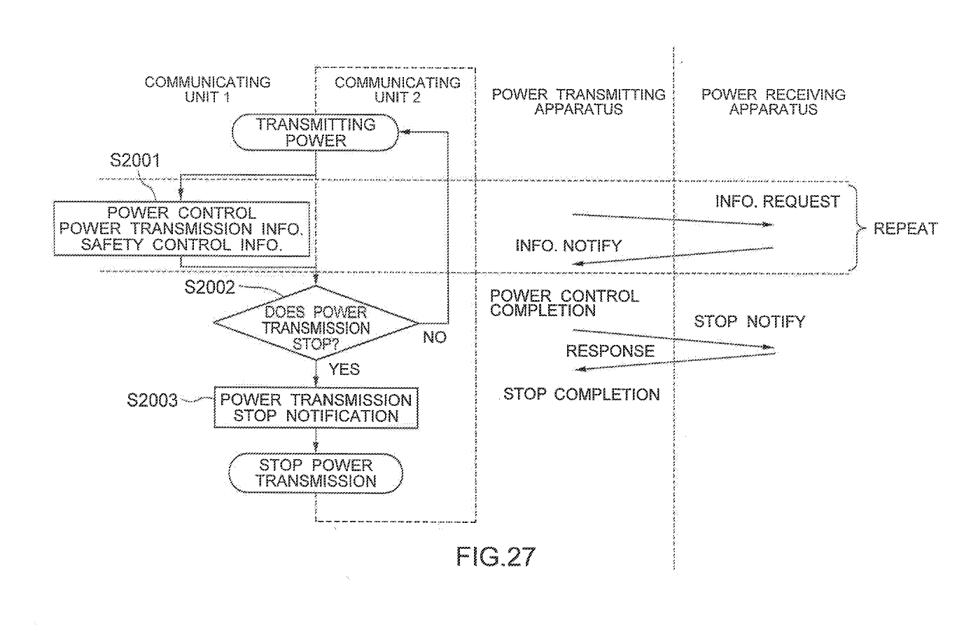

### (FIG. 27: A Flowchart and a Communication Procedure During Power Transmission in the Normal Mode (the State 1) of the Wireless Power Transmission System According to the Embodiment)

A flowchart during power transmission and a communication procedure of wireless power transmission in the normal mode are shown in FIG. 27. A flow shown in FIG. 27 is explained in order.

During the wireless power transmission, the wireless power transmission system cyclically or suddenly performs a check of a transmission state, safety control, and radio communication for charging control to a battery (S2001). This is performed using the communicating unit 1. During power transmission, when communication is performed in the communicating unit 2 using, in particular, load modulation, deterioration in power transmission efficiency is caused. Therefore, it is desirable to use the communicating unit 1. When it is necessary to stop the power transmission (Yes in S2002) or some error occurs, the wireless power transmission system sends a power transmission stop notification (S2003) and stops the power transmission. Note that when communication timing, a data type, and a data cycle are exchanged beforehand, the wireless power transmission system may cyclically transmit information unilaterally from the power receiving apparatus without transmitting a request from the power transmitting apparatus shown in FIG. 27.

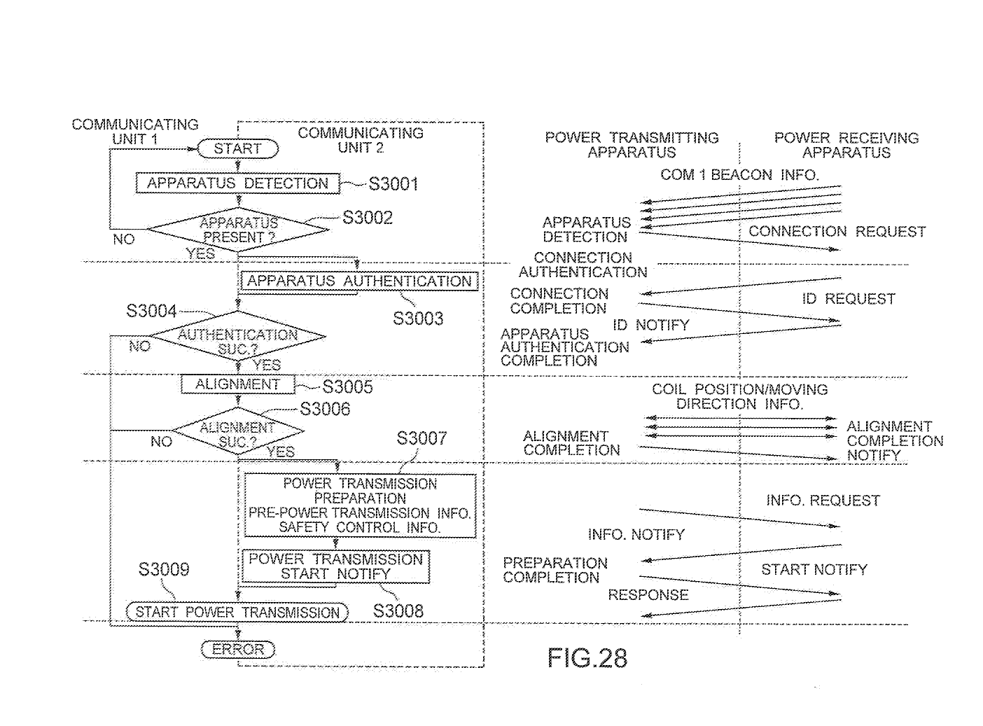

### (FIG. 28: A Flowchart and a Communication Procedure at the Time of Startup in the Interruption 1 Mode (the State 2) of the Wireless Power Transmission System According to the Embodiment)

A flowchart and a communication procedure at the time of startup of wireless power transmission in the interruption 1 mode of the wireless power transmission system according to the embodiment is shown in FIG. 28. The interruption 1 mode is a state in which communication by the communicating unit 1 is interrupted in a short term or a long term. Examples of a method of determining that communication is interrupted include a method of counting the number of times timeout of communication and a data loss occur and determining the counted number of times with respect to a threshold, and more specifically, include a method of determining that communication is interrupted if the timeout and the data loss continuously occur several times and a method of setting upper limits of the timeout and the data loss and determining that communication is interrupted if the timeout and the data loss exceed the upper limits in a fixed time. Note that as the method of determining interruption, besides the methods explained above, various methods can be applied without departing from the above. It can be determined whether the communicating unit 1 is interrupted only when wireless connection and communication are performed by the communicating unit 1. Therefore, the wireless power transmission system transitions to the interruption 1 mode at the first stage of the use of the communicating unit 1.

In the interruption 1 mode, the control is executed up to the power transmission start according to the same procedures as the procedures in the normal mode. However, the interruption 1 mode is different from the normal mode in that all the kinds of information exchanged by the communicating unit 1. in the normal mode are exchanged by the communicating unit 2.

First, in apparatus detection (S3001), the method of detecting a power receiving apparatus using the communicating unit 2, a sensor, a camera, a separate communication apparatus, or the like may be used. Any method other than the detection by the communicating unit 1 can be applied. If a power receiving apparatus is found (Yes in S3002), the wireless power transmission system shifts to the next procedure. If a power receiving apparatus is not found (No in S3002), the wireless power transmission system repeats the apparatus detection.

Subsequently, the wireless power transmission system performs apparatus authentication (S3003) using the communicating unit 2 as in the normal mode. When the apparatus authentication is successful (Yes in S3004), the wireless power transmission system shifts to the next procedure. When the apparatus authentication is unsuccessful (No in S3004), the wireless power transmission system transitions to an error state. Note that rather than transitioning to the error state when the apparatus authentication is unsuccessful once, the wireless power transmission system may transition to the error state when the apparatus authentication is continuously unsuccessful a plurality of times. Note that the wireless power transmission system may perform the apparatus authentication simultaneously with the apparatus detection or before the apparatus detection.

When the apparatus authentication ends, the wireless power transmission system performs alignment (S3005). When a power transmission characteristic acquired in the communicating unit 2 is used for the alignment, it is desirable to use the communicating unit 2. However, any method of aligning a position using an apparatus other than the communicating unit 1 such as a sensor, a camera, or a communication apparatus can be applied. Note that the alignment could be sometimes unnecessary depending on an application to be applied. For example, when a setting position of the power receiving apparatus is explicitly marked in a power transmitting apparatus main body and a user arranges the power receiving apparatus in the setting position, communication is unnecessary and the user performs the alignment. The order of the alignment may be interchanged with the order of the apparatus detection and the apparatus authentication performed at the pre-stage of the alignment. It is also possible to perform, at the time of the alignment, calibration necessary at the time of power transmission start.

When the alignment ends (Yes in S3006), subsequently, for power transmission preparation, the wireless power transmission system exchanges pre-power transmission information and safety control information necessary at the time of start of power transmission (S3007). The information is transmitted using the communicating unit 2. At this point, information for notifying that the communicating unit 1 is interrupted and basic information for using the wireless power transmission and the inter-coil communication in common are exchanged in advance. Examples of the basic information include several items described below.
Communication timing
Data type
Data cycle

The communication timing is necessary to separate the wireless power transmission and the inter-coil communication, for example, when the wireless power transmission and the inter-coil communication are shared in a time-division manner.

In FIG. 10, a communication procedure performed, for example, when the wireless power transmission and the inter-coil communication are shared in a time-division manner is shown. From FIG. 10, the communication timing indicates a period for carrying out the initial inter-coil communication after the wireless power transmission is started. According to the communication timing, both the power transmitting and receiving apparatuses independently shift to a transmission and reception mode by the inter-coil communication. The communication timing can be realized by using, for example, the number of clocks for which a period from the start of the wireless power transmission until the inter-coil communication elapses. However, other methods may be used. By exchanging the communication timing in advance, it is possible to realize the inter-coil communication according to respective determinations in both the power transmitting and receiving apparatuses. Note that in FIG. 10, when the wireless power transmission system shifts from the wireless power transmission to the inter-coil communication or when the wireless power transmission system shifts from the inter-coil communication to the wireless power transmission, the wireless power transmission and the inter-coil communication respectively have margin periods to prevent breakage of the apparatuses and the like. However, the margin periods may be omitted.

The initial inter-coil communication can be carried out according to the communication timing. However, the inter-coil communication is cyclically carried out according to a data type and a data cycle exchanged in advance. The data cycle is sometimes different depending on the data type. In that case, a plurality of data types need to be mixed and transmitted. In FIG. 10, one kind of the data type is transmitted according to the data cycle. An example of a transmission method for transmitting a plurality of kinds of data types according to data cycles is shown in FIG. 11.

When a plurality of kinds of data types having different communication timings and data cycles are simultaneously transmitted, it is necessary to perform communication according to the data cycles of the respective data types as shown in FIG. 11. Although not shown in FIG. 11, when there are calls for a plurality of data types are performed at the same timing at a certain instance, the plurality of data types are simultaneously transmitted. The above method is an example. For example, when communication timing is the same, a plurality of kinds of data types may be treated with reference to a data cycle of the least common multiple of respective data cycles. In that case, it is necessary to allow calls for a plurality of data types at the same timing. When the wireless power transmission and the inter-coil communication are performed in a time-division manner as shown in FIG. 11, it is necessary to reduce a frequency of the inter-coil communication in order to improve transmission efficiency of the wireless power transmission. Therefore, calls for the plurality of data types are preferably performed at the same timing as much as possible. Therefore, it is preferable to adopt a method with the smallest frequency of the inter-coil communication on the basis of the communication timing and the data cycle.

Note that the determination of communication timing and call timing is performed by the power transmission-side control unit 34 of the power transmitting apparatus. The power transmitting apparatus notifies the power receiving apparatus of the communication timing and the call timing determined by the power transmission-side control unit 34. The power receiving apparatus operates on the basis of information concerning the communication timing and the call timing.

Information concerning the data type and the data cycle is extremely important parameters in the interruption 1 mode. For example, the pre-power transmission information and the safety control information are included as types of data in the normal mode. In the interruption 1 mode, a data type is designated at the time of startup and only designated information is exchanged during power transmission. Consequently, it is possible to minimize resources used for communication and carry out power transmission control while minimizing deterioration in the power transmission efficiency. Note that as data types used in the interruption 1 mode, for example, electric power, electric current, and voltage information at respective measurement points, resistance information of a load or, when the load is a battery, charging information, and the like are included. However, the data types are not limited to such information. It is possible to improve the power transmission efficiency by saving information to be communicated as much as possible. Further, at this point, the data cycle is also exchanged. Basically, any control is performed according to a certain specific cycle and communication concerning the control is cyclically performed on the basis of the cycle. In particular, in the case of the wireless power transmission apparatus, the power transmitting apparatus requests necessary data and the power receiving apparatus returns data corresponding to the request. The exchange of the data is carried out at a fixed cycle. At this point, a cycle of data and a type of the data called from the power transmitting apparatus are exchanged before the start of power transmission. Consequently, it is possible to acquire data necessary for the control from the power receiving apparatus without performing a data request from the power transmitting apparatus. In other words, it is possible to realize transmission control for the wireless power transmission according to cyclic transmission of data in one-way from the power receiving apparatus. Consequently, it is possible to reduce resources necessary for communication and improve the power transmission efficiency.

When the exchange of the pre-power transmission information and the safety control information ends, the wireless power transmission system transmits a power transmission start notification (S3008) and starts power transmission (S3009). The wireless power transmission system also performs the power transmission start notification using the communicating unit 2. The wireless power transmission system may start the power transmission without transmitting the power transmission start notification.

Note that in FIG. 28 and other examples, the wireless power transmission and the inter-coil communication are realized in a time-division manner. However, various methods other than the time division can be applied. For example, if a method such as frequency division is used, it is possible to realize the inter-coil communication without deteriorating the transmission efficiency of the wireless power transmission. Even when load modulated communication is applied, it is possible to adopt a configuration in which the communication can be performed during execution of the wireless power transmission. Various methods can be applied without departing from the above.

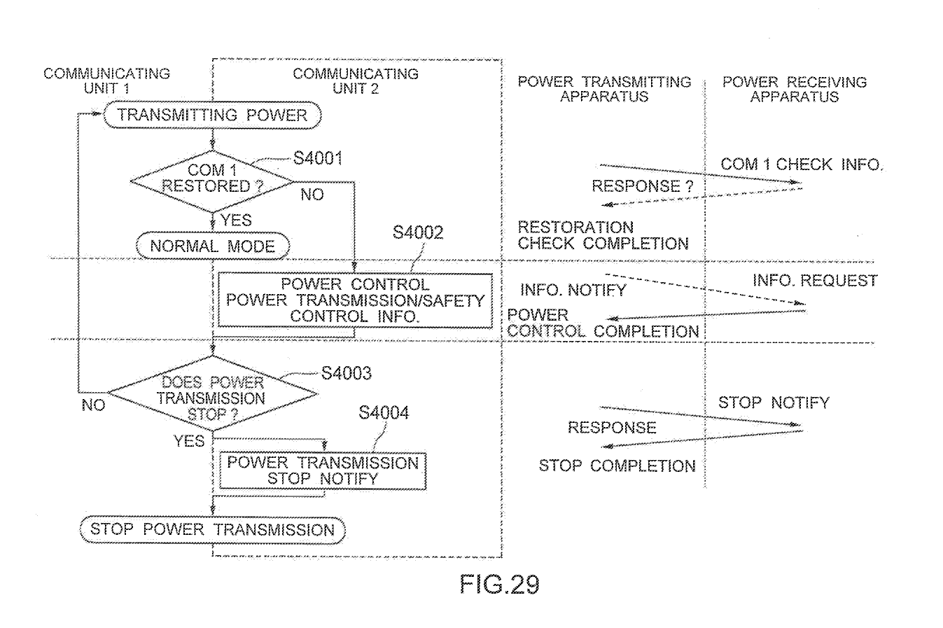

### (FIG. 29: A Flowchart and a Communication Procedure During Power Transmission in the Interruption 1 Mode (the State 2) of the Wireless Power Transmission System According to the Embodiment)

A flowchart and a communication procedure during power transmission of the wireless power transmission in the interruption 1 mode are shown in FIG. 29. The flowchart is substantially the same as the flowchart during the power transmission in the normal mode. All communications are performed using the communicating unit 2. The flowchart is different from that in normal mode in that when restoration of the communicating unit 1 is detected (Yes in S4001), the wireless power transmission system switches the communicating unit to the communicating unit 1 and transitions to the normal mode. In order to check the communication restoration of the communicating unit 1, the wireless power transmission system transmits communicating unit 1 check information from the power transmitting apparatus and performs determination of the communication restoration according to the content of a response to the communicating unit 1 check information. When the power transmission information and the safety control information are exchanged (S4002), as explained above, the wireless power transmission system performs exchange of the information on the basis of a data type and a data cycle exchanged before the start of power transmission as explained above. Processing in steps S4003 and S4004 is the same as the processing in steps S2002 and S2003 in the normal mode shown in FIG. 27. Note that in FIG. 29, when the power transmission information and the safety control information are exchanged (S4002), a power transmission information and safety control information request is issued from the power transmitting apparatus and information corresponding to the power transmission information and safety control information request is fed back from the power receiving apparatus. However, communication for the exchange of the information is mainly carried out at a fixed data cycle. Therefore, when a data type and a data cycle are exchanged beforehand, the wireless power transmission system may transmit, on the basis of the data type and the data cycle exchanged beforehand, data corresponding to the data type and the data cycle (in this case) without issuing the power transmission information and safety control information request from the power transmitting apparatus and without the power receiving apparatus, which is a slave, being controlled by the power transmitting apparatus. Consequently, it is possible to reduce communication opportunities by the communicating unit 2 during power transmission and improve deterioration in power transmission efficiency.

An example of a procedure in the case of transitioning from another state to the interruption 1 mode during power transmission is shown in FIG. 13. When the communicating unit 1 is interrupted during power transmission (Yes in S501), the interrupt of the communicating unit 1 can be determined by the power transmitting apparatus only as well. Therefore, first, the wireless power transmission system stops the power transmission for safety (S502). Thereafter, the wireless power transmission system performs exchange of pre-power transmission information and safety control information using the communicating unit 2 (S503). At this point, communication timing, a data type, and a data cycle are included in the pre-power transmission information. After the exchange of the pre-power transmission information, the wireless power transmission system transitions to the interruption 1 mode (S504). The wireless power transmission system transmits a power transmission start notification (S505) and starts power transmission. In that case, transmission control is executed on the basis of communication timing, data type, and data cycle information exchanged beforehand. The above is an example. Other methods can be used without departing from the above. Note that when the inter-coil communication is performed as the communicating unit 2, for example, when a method that can realize the inter-coil communication while continuing the wireless power transmission such as frequency division is used, the wireless power transmission system does not stop the power transmission. The wireless power transmission system may exchange the pre-transmission information and the safety control information while continuing the wireless power transmission.

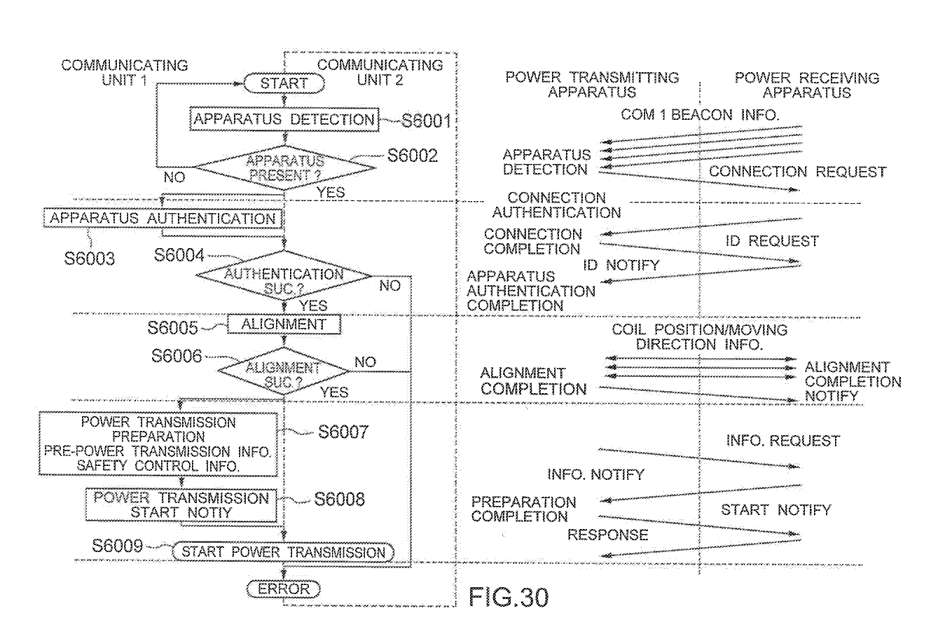

### (FIG. 30: A Flowchart and a Communication Procedure at the Time of Startup in the Interruption 2 Mode (the State 3) of the Wireless Power Transmission System According to the Embodiment)

A flowchart and a communication procedure at the time of startup of the wireless power transmission in the interruption 2 mode are shown in FIG. 30. The interruption 2 mode is a state in which communication by the communicating unit 2 is interrupted in a short term or a long term. Examples of a method of determining that communication is interrupted include a method of counting the number of times timeout of communication and a data loss occur and determining the counted number of times with respect to a threshold, and more specifically, include a method of determining that communication is interrupted if the timeout and the data loss continuously occur several times and a method of setting upper limits of the number of times of the timeout and the data loss and determining that communication is interrupted if the timeout and the data loss exceed the upper limits in a fixed time. Note that as the method of determining interruption, besides the methods explained above, various methods can be applied without departing from the above.

As the first procedure, the wireless power transmission system performs apparatus detection for searching for a power receiving apparatus (S6001). For the apparatus detection, the communicating unit 1 may be used or a sensor, a camera, or a separate communication apparatus may be used. If a power receiving apparatus is found (Yes in S6002), the wireless power transmission system shifts to the next procedure. If a power receiving apparatus is not found (No in S6002), the wireless power transmission system repeats the apparatus detection. The apparatus detection may be always performed or may be cyclically performed. When the apparatus detection is cyclically performed, consumed power can be reduced compared with power consumed when the apparatus detection is always performed.

When a power receiving apparatus is detected by the apparatus detection, the wireless power transmission system performs authentication of the power receiving apparatus in order to determine whether the power receiving apparatus is a malicious apparatus having a purpose of a power theft or a obstacle (S6003). The apparatus authentication is performed using the communicating unit 1. When the communicating unit 2 is used, since the communicating unit 2 has a communicable range wider than a communicable range of the communicating unit 1, there are risks of wiretapping and piracy. Therefore, firm security measures may be taken according to necessity. Note that rather than transitioning to the error state when the apparatus authentication is unsuccessful once, the wireless power transmission system may transition to the error state when the apparatus authentication is continuously unsuccessful a plurality of times. The wireless power transmission system may perform the apparatus authentication simultaneously with the apparatus detection or before the apparatus detection.

Note that it can be determined whether the communicating unit 2 is interrupted only when communication is performed by the communicating unit 2 in the apparatus authentication unless the communicating unit 2 is used for the apparatus detection. Therefore, the wireless power transmission system transitions to the interruption 2 mode at the first stage of the use of the communicating unit 2.

When the apparatus authentication ends (Yes in S6004), the wireless power transmission system performs alignment (S6005). For the alignment, the communicating unit 1 may be used. Any method of aligning a position using an apparatus other than the communicating unit 2 such as a sensor, a camera, or a separate communication apparatus can be applied. Note that the alignment could be sometimes unnecessary depending on an application to be applied. For example, when a setting position of the power receiving apparatus is explicitly marked in a power transmitting apparatus main body and a user arranges the power receiving apparatus in the setting position, communication is unnecessary and the user performs the alignment. When the alignment is performed, it is also possible to perform calibration necessary at the time of start of power transmission.

When the alignment ends (Yes in S6006), subsequently, the wireless power transmission system exchanges pre-power transmission information and safety control information necessary at the time of start of power transmission (S6007). The information is transmitted using the communicating unit 1. At this point, in the interruption 2 mode, information for notifying the power receiving apparatus that the communicating unit 2 is interrupted may be added.

When the exchange of the pre-power transmission information and the safety control information ends, the wireless power transmission system transmits a power transmission start notification using the communicating unit 1 (S6008) and starts power transmission (S6009). The wireless power transmission system may start the power transmission without transmitting the power transmission start notification.

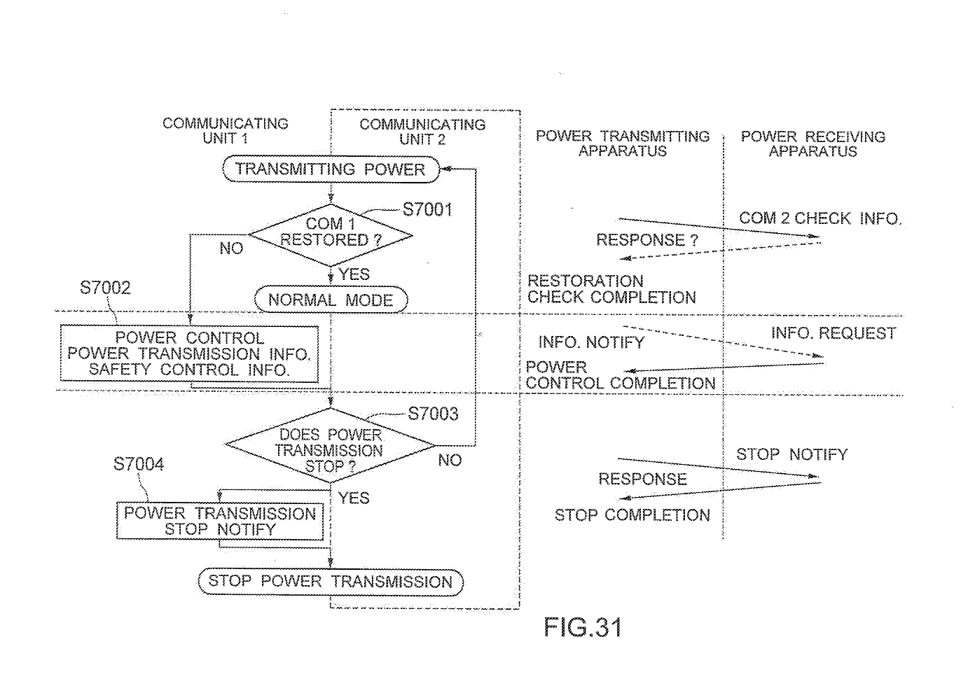

### (FIG. 31: A Flowchart and a Communication Procedure During Power Transmission in the Interruption 2 Mode (the State 3) of the Wireless Power Transmission System According to the Embodiment)

A flowchart and a communication procedure during power transmission of the wireless power transmission in the interruption 2 mode are shown in FIG. 31. The flowchart is substantially the same as the flowchart during power transmission in the normal mode. When restoration of the communicating unit 2 is detected (Yes in S7001), the Wireless power transmission system transitions to the normal mode. However, since switching of the communicating unit is not performed, a substantial change does not occur. Processing in steps S7002, S7003, and S7004 is the same as the processing in steps S2001, S2002, and S2003 of the normal mode shown in FIG. 27.

Note that, in the interruption 2 mode, it is possible to omit the power transmission information and safety control information request from the power transmitting apparatus at the time of power control as in the interruption 1 mode. However, a power transmission efficiency improving effect as in the interruption 1 mode is not obtained.

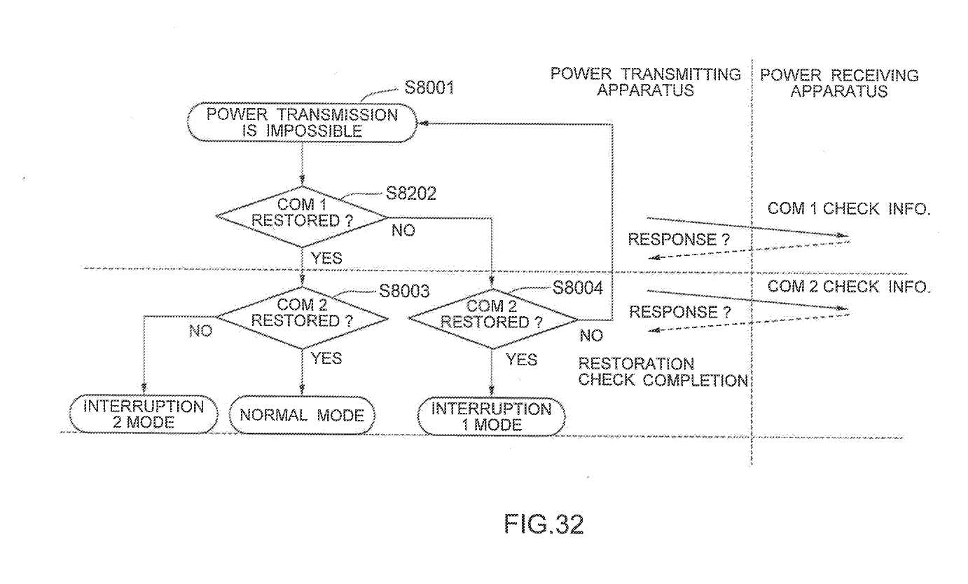

### (FIG. 32: Operation at the Time of Startup and During Power Transmission in the Full Interruption Mode of the Wireless Power Transmission System According to the Embodiment)

When both of the communicating unit 1 and the communicating unit 2 are interrupted, the wireless power transmission system transitions to the full interruption mode. In this full interruption mode, irrespective of whether the power transmission is started up or being performed, the wireless power transmission system determines that the wireless power transmission system is in a power transmission impossible state (S8001) and does not perform the wireless power transmission. In this mode, the control unit repeatedly performs a check of communication restoration in both of the communicating unit 1 and the communicating unit 2 (S8002, S8003, and S8004). When any one of or both of the communicating unit 1 and the communicating unit 2 are restored, the wireless power transmission system transitions to the respective modes and performs startup processing or power transmission.

### (An Operation Example of the Communicating Unit 2 at the Time of an Emergency Stop in the Wireless Power Transmission System According to the Embodiment)

In the wireless power transmission system according to the embodiment, in a state in which power transmission needs to be immediately emergently stopped because of heat generation of the power receiving apparatus, breakage of an apparatus, overvoltage, overcurrent, or the like, it is necessary to perform radio communication in order to notify that the power transmission is emergently stopped. At this point, when the emergency stop of the power supply is notified using the communicating unit 1 in which a general communication standard such as wireless LAN or Bluetooth is used, since a delay is caused by processing in respective protocols or processing by an access control unit such as a MAC layer, it is extremely difficult to satisfy a delay time allowed until the emergency stop. Therefore, in this proposal, when the emergency stop is immediately necessary, an emergency stop signal is exchanged using the communicating unit 2 in both the normal mode and the interruption 1 mode unless the communicating unit 2 is interrupted. When the communicating unit 2 is used, it is easy to change the configuration of a frame. For example, if a preamble for emergency stop including a code different from a preamble part usually used in the communicating unit 2 is used as a preamble part of a frame as shown in FIG. 18, it is possible to stop the power transmission when the preamble part is received. Further, since the preamble for emergency stop is repeatedly transmitted without including a data part until the power transmission is stopped, it is possible to improve a reception success probability of the preamble for emergency stop.

Rather than using the preamble for emergency stop, the protection circuit 42 included in the power receiving apparatus in a wireless power transmission system shown in FIG. 25 may be actuated to transmit an emergency stop signal. The protection circuit 42 of the power receiving apparatus performs operation for, for example, changing the load to an open state to prevent electric power from being supplied to the load. At this point, the fluctuation of load impedance of the power receiving apparatus in view of the power transmitting apparatus side occurs. Characteristic changes of a voltage and an electric current in the power transmitting apparatus appears. By detecting the voltage and electric current fluctuations in the power transmitting apparatus, it is possible to determine that the protection circuit 42 of the power receiving apparatus operates. The communicating unit 2 in the embodiment is the inter-coil communication. The inter-coil communication is a method of communication via changes in a voltage and an electric current. Therefore, the control unit 34 connected to the communicating unit 2 of this proposal can detect a protection circuit operation of the power receiving apparatus. When the control unit 34 detects the operation of the protection circuit 42, it is possible to stop power transmission.

Note that changes in a voltage and an electric current on the power transmitting apparatus side at the time of the protection circuit operation are different depending on circuit topologies. Therefore, it is necessary to select an optimum method for determining the protection circuit operation according to each of the topologies. Note that examples of a place where the voltage and electric current changes are measured on the power transmitting apparatus side of the protection circuit operation in this case include a place between the power transmission antenna and the inverter, a place between the power distributing unit and the inverter, and a place between the power supply unit and the inverter. However, besides these places, the place for measuring the voltage and electric current changes may be any place where the protection circuit operation is read in the power transmitting apparatus.

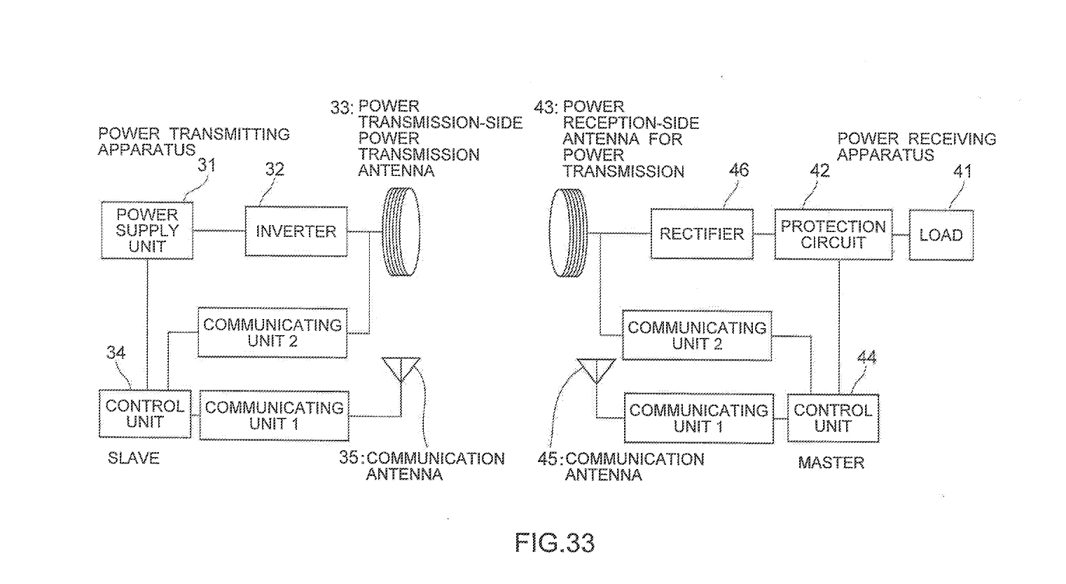

### (FIG. 33: A Second Configuration Example of the Wireless Power Transmission System According to the Embodiment)

A second configuration example of the wireless power transmission system according to the embodiment is shown in FIG. 33. Compared with FIG. 25, which is the first configuration example, there is no change in the components of the power transmitting apparatus and the power receiving apparatus. Positions of a master and a slave are only different from the positions in the first configuration example. The second configuration example of the wireless power transmission system according to the embodiment is different in that the power reception-side control unit 44 of the power receiving apparatus functions as a master and executes various kinds of control for the wireless power transmission and control performed when the power transmission-side and power reception-side communicating units 1 and 2 are interrupted. In the second configuration example, the power transmission-side control unit 34 of the power transmitting apparatus functions as a slave and receives a command from the power reception-side control unit 44 and operates.

### (Second Operation Example of the Wireless Power Transmission System According to the Embodiment)

A second operation example and a flowchart in the respective mode in the wireless power transmission system according to the present embodiments are substantially the same as the first operation example. The second operation example and the flowchart are different from those in the first operation example in that all kinds of control and start of communication are performed in the power reception-side control unit 44 of the power receiving apparatus, which is the master. That is, arrows of the communication procedures in the figures are only opposite. Therefore, explanation of the second operation example and the flowchart is omitted.

The embodiments can be widely applied to wireless power transmission techniques and can be applied to a wireless communication device as a highly reliable technique concerning wireless communication.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A power transmitting apparatus comprising:
a first antenna;
a first communicating unit to perform communication with a power receiving apparatus using the first antenna;
a power supply unit to generate electric power;
a second antenna to transmit the electric power generated by the power supply unit to the power receiving apparatus;
a second communicating unit to perform communication with the power receiving apparatus using the second antenna;
a measuring unit to measure first communication quality of the first communicating unit and second communication quality of the second communicating unit; and
a control unit to communicate, while power transmission to the power receiving apparatus is performed, transmission control information with the power receiving apparatus using the first communicating unit or the second communicating unit and control the power transmission to the power receiving apparatus based on the transmission control information,
wherein the control unit selects any one of the first communicating unit and the second communicating unit according to the first communication quality and the second communication quality to communicate the transmission control information.

2. The power transmitting apparatus according to claim 1, wherein when the first communication quality is equal to or higher than a first standard, the control unit selects the first communicating unit irrespective of the second communication quality.

3. The power transmitting apparatus according to claim 2, wherein when the first communication quality changes from a value equal to or larger than the first standard to a value smaller than the first standard and the second communication quality is equal to or higher than a second standard, the control unit switches from the first communicating unit to the second communicating unit.

4. The power transmitting apparatus according to claim 1,
wherein the control unit communicates the transmission control information with the power receiving apparatus before start of the power transmission using the first communicating unit or the second communicating unit,
the transmission control information includes at least one of a plurality of types of information, and
before start of the power transmission, when the first communication quality is equal to or higher than a first standard and the second communication quality is equal to or higher than a second standard, the control unit switches between the first and second communicating units according to the type of information to be communicated.

5. The power transmitting apparatus according to claim 4, wherein the transmission control information includes at least one selected from the following:
power related information including any one of voltage information, current information, and power information in at least one of the power transmitting apparatus and the power receiving apparatus,
authentication information concerning at least one of the power transmitting apparatus and the power receiving apparatus,
temperature information concerning at least one of the power transmitting apparatus and the power receiving apparatus,
load information of the power receiving apparatus,
anomaly information for notifying an anomaly that occurs in the power transmitting apparatus or the power receiving apparatus,
communication timing information between the power transmitting apparatus and the power receiving apparatus,
type information of data communicated between the power transmitting apparatus and the power receiving apparatus, and
data cycle information for communicating the data.

6. The power transmitting apparatus according to claim 1, wherein when the control unit switches from the first communicating unit to the second communicating unit, the control unit reduces an amount of the transmission control information to be communicated.

7. The power transmitting apparatus according to claim 1, wherein when the control unit switches from the second communicating unit to the first communicating unit, the control unit increases an amount of the transmission control information to be communicated.

8. The power transmitting apparatus according to claim 1, wherein when an anomaly detection signal is received from the power receiving apparatus in the second communicating unit, the control unit stops the power transmission.

9. The power transmitting apparatus according to claim 1, wherein the second antenna is a coil.

10. A power receiving apparatus comprising:
a first antenna;
a first communicating unit to perform communication with a power transmitting apparatus using the first antenna;
a second antenna to receive electric power from the power transmitting apparatus;
a load to consume the electric power received by the second antenna;
a second communicating unit to perform communication with the power transmitting apparatus using the second antenna;
a measuring unit to measure first communication quality of the first communicating unit and second communication quality of the second communicating unit; and
a control unit to communicate, while power transmission is performed from the power transmitting apparatus, transmission control information with the power transmitting apparatus using the first communicating unit or the second communicating unit and control the power transmission based on the transmission control information,
wherein the control unit selects any one of the first communicating unit and the second communicating unit according to the first communication quality and the second communication quality to communicate the transmission control information.

11. The power receiving apparatus according to claim 10, wherein when the first communication quality is equal to or higher than a first standard, the control unit selects the first communicating unit irrespective of the second communication quality.

12. The power receiving apparatus according to claim 11, wherein when the first communication quality changes from a value equal to or larger than the first standard to a value smaller than the first standard and the second communication quality is equal to or higher than a second standard, the control unit switches from the first communicating unit to the second communicating unit.

13. The power receiving apparatus according to claim 10,
wherein the control unit communicates the transmission control information with the power transmitting apparatus before start of the power transmission by the power transmitting apparatus using the first communicating unit or the second communicating unit,
the transmission control information includes at least one of a plurality of types of information, and
before start of the power transmission, when the first communication quality is equal to or higher than a first standard and the second communication quality is equal to or higher than a second standard, the control unit switches between the first and second communicating units according to the type of information to be communicated.

14. The power transmitting apparatus according to claim 10, wherein the transmission control information includes at least one selected from the following:
power related information including any one of voltage information, current information, and power information in at least one of the power transmitting apparatus and the power receiving apparatus,
authentication information concerning at least one of the power transmitting apparatus and the power receiving apparatus,
temperature information concerning at least one of the power transmitting apparatus and the power receiving apparatus,
load information of the power receiving apparatus,
anomaly information for notifying an anomaly that occurs in the power transmitting apparatus or the power receiving apparatus,
communication timing information between the power transmitting apparatus and the power receiving apparatus,
type information of data communicated between the power transmitting apparatus and the power receiving apparatus, and
data cycle information for communicating the data.

15. The power receiving apparatus according to claim 10, wherein when the control unit switches from the first communicating unit to the second communicating unit, the control unit reduces an amount of the transmission control information to be communicated.

16. The power receiving apparatus according to claim 10, wherein when the control unit switches from the second communicating unit to the first communicating unit, the control unit increases an amount of the transmission control information to be communicated.

17. The power receiving apparatus according to claim 10, further comprising a protection circuit to monitor supply of the electric power to the load,
wherein upon detecting an anomaly, the protection circuit shuts off power supply to the load.

18. The power receiving apparatus according to claim 17, wherein when the anomaly is detected by the protection circuit, the second communicating unit transmits an anomaly detection signal to the power transmitting apparatus.

19. The power receiving apparatus according to claim 10, wherein the second antenna is a coil.
